(19) United States
(12) Patent Application Publication
(10) Pub. No.: US 2001/0022334 A1
(43) Pub. Date: Sep. 20, 2001

(54) Armrest apparatus

(76) Inventors: Koichi Iwata, Santo-Gun (JP); Hiroshi Saito, Matsudo-Shi (JP)

Correspondence Address: TRASK BRITT, P.O. BOX 2550, SALT LAKE CITY, UT, 84110, US

(21) Appl. No.: 09/753,780

(22) Filed: Jan. 3, 2001

(30) Foreign Application Priority Data
Jan. 7, 2000 (JP) 1324/2000
Apr. 6, 2000 (JP) 104473/2000
May 31, 2000 (JP) 161768/2000
Dec. 19, 2000 (JP) 2000/384642

(51) Int. Cl. B68G 5/00; A47G 29/00

(52) U.S. Cl. 248/118; 248/118.3; 248/371

(57) ABSTRACT

The present invention relates to a pivotal armrest apparatus which comprises a cradle having a direct pivotal mechanism mounted on an anti-slip member. The pivotal mechanism automatically converts with the anti-slip member from the irregular movements of fingers (i.e. typing a keyboard) into stress releasing movements over the forearm without impairing a specific part of the wrist, whereby RSI can hardly be generated on the upper torso, nerves, and muscles. Also, the armrest enables a proper degree of rigidity to allow no drifting of the fingers, improves the repeatability of the finger position, and makes the installation area minimum while it is detachable and used as a comfortable rest means for respite.

### BACKGROUND OF THE INVENTION

1. Field of the Invention

This invention relates to a pivotal armrest apparatus having a pivotal mechanism directly mounted on an anti-slip member. The pivotal mechanism automatically converts with the anti-slip member from irregular finger-movements into stress releasing movements, whereby RSI (Repetitive Strain Injury) can hardly be generated on the upper torso, nerves, and muscles. Also, the armrest makes the installation area minimum while it is detachable and used as a comfortable rest means for respite.

2. Description of the Related Art

Usually, while keyboard users or typists use standard layout keyboards for carrying out e.g. word processing, their fingers are held over the home row position of it with their forearms extending horizontally at the height of the keyboard and their palms in parallel with the surface of it. However, such a standard attitude causes user to be tensioned at the hand, palm, forearm, upper arm, and backs. While the QWERTY-layout is a standard for keyboard, a variety of modified keyboards has been proposed for alleviating the discomfort of muscles, and nerves of users. However, those modifications are not widely accepted because users favor psychologically for the QWERTY-layout. It is thus desired to develop a user-friendly keyboard which can successfully reduce RSI while its design remains not departing from the standard layout.

B1) Japanese Patent Laid-open No. (Heisei)7-200121 describes a keyboard having a pointer and a tilting device for carrying out a pointing action with the hand remaining placed over the keyboard. In particular, the keyboard has an ergonomic arrangement comprising a left key bank and a right key bank separated at an angle of 20 to 36 degrees by an intermediate fan-like shaped sector which extends towards the front of the keyboard and has a track ball provided therein.

B2) U.S. Pat. No. 5,058,840 (Moss et al) describes a device which is slidably moved while supporting the forearm of a user from bottom.

B3) U.S. Pat. No. 5,398,896 (Terbrack) describes a device which is longitudinally moved slidably and pivotally moved about z-axis and has a linkage mechanism.

B4) U.S. Pat. No. 5,884,974 (Bergstern et al) describes a chair having armrests for supporting wrists which are adjustable in the height and pivotal about z-axis and also slidable longitudinally.

B5) Japanese Patent Laid-open No. (Heisei)10-211794 describes an arm support for a keyboard-user having a pivot attached to the distal end of a linkage mechanism. The linkage is secured to a desk edge by clamp. The device has a joint (pivot) for allowing the forearm of a user to operate smoothly.

B6) U.S. Pat. No. 5,158,256 (Gross) describes a device moving longitudinally and having an adjustable means in the height of the wrist.

B7) U.S. Pat. No. 5,597,208 (Bonutti) describes a device for a chair having a transfer means mounted on the upper end of an L-shaped support pipe thereof for sliding movement horizontally and rotary movements about three rotational axes independently.

B8) U.S. Pat. No. 5,683,064 (Copeland) describes a manually positionable support device, especially for a work surface, keyboard support or similar support platform.

B9) U.S. Pat. No. 5,730,408 (McAllister, et al) describes a workstation support for a keyboard and a mouse.

B10) U.S. Pat. No. 5,810,301 (McGrath, et al) describes an adjustable, sturdy upper body support assembly for keyboard operators.

B11) U.S. Pat. No. 6,042,064 (Hong) describes a wrist support suitable for use by computer users to reduce RSI comprises a cushion mounted from an articulated strut so as to be rotatable about three axes.

However, all the above described technologies have the following disadvantages. A subjective inventor-side-evaluation (good,medium,low,poor,void) of each technology is shown at the last line as follows; support function of the arm( ), pivot function( ), detachable function( ), anti-RSI function( ), rest function( ), size( ), durability( ), production cost( )

C1) The keyboard described in B1) supports mainly palms but fails to provide any means for lifting the forearm in the air. The static load which results from holding forearms over the keyboard for a long time can hardly be decreased fundamentally.

CB1:support(void), pivot(void), detach(void), RSI(void), rest(void), size( ), durability( ), cost( )

C2) The device described in 840 (Moss et al) has a support movable so as to be: (a) freely pivotable about z-axis; (b) freely slidable along its length. A cradle is supported from the distal end of the support so as to be freely pivotable about a yaw-axis, and in addition to pitch in a fore and aft direction relative to the longitudinal axis of the cradle. The pitch motion is controlled in part by biasing springs which bias the cradle to a neutral pitch position when an out-of-balance force is removed from the cradle. The slide means consisting of a concentric cylindrical form is moved longitudinally, it suffers from a high sliding resistance. The arm support is secured to the top of a table with a vacuum suction plate at its base. The support is used on the outside area of the base, and constantly received a gravity-moment created by the arm to the overturning direction. The required space for the slide movement is large above the top of the table, increasing the overall dimensions of the support. The cradle is supported by biasing springs, the forearm holds to stay substantially at a constant angular attitude, and this causes RSI during a long-term operation. The springs also cause fingers to drift slightly from one location to another, whereby the accurate positioning of fingers needs its nerves and muscles being tensioned continuously.

CB2:support(medium), pivot(void), detach(low), RSI(low), rest(void), size(poor), durability(poor), cost(poor)

C3) The device described in 896 (Terbrack) comprises an elongate guide-track and a pair of support assemblies which are adapted to support user's palms adequately. Each of the support assemblies comprises a carriage slidably engaged to the guide-track and a linkage pivotally connected to the carriage. The pivotal connection and the slidable engagement of the carriage facilitates dynamic lateral and longitudinal movement of the support and hence the user's hands relative to the guide track. A pin in the linkage is hardly increased in the diameter, the strength is hardly enough to. The height control along z-axis is hardly considered, the forearm is hardly free from RSI. The rotatable linkage causes fingers to drift slightly from one location to another, the supported arm needs its nerves and muscles being tensioned continuously.

CB3:support(poor), pivot(void), detach(void), RSI(poor), rest(void), size(poor), durability(poor), cost(poor)

C4) The arm support described in 974 (Bergstern) is installed at a desk edge with clamp, and this causes a drawback of the drawer. The support oppupies a broad surface of the desk. The sliding shaft of the support is constructed by a point contact, it receives concentrated loads and if worse, will bend down. The support once installed may hardly be removed, and includes a large number of components thus increasing the overall cost.

CB4:support(low), pivot(void), detach(void), RSI(poor), rest(void), size(poor), durability(poor), cost(poor)

C5) The arm support described in B5) has a similar drawback to 974 (Bergston). A linkage to the support occupies a bulky space of the desk, or the clamp shape of the linkage varies very widely matching to the edge shapes of the desks to be attached to. The clamp has a weak strength and impairs the surface of the desk. After a long-term use, the pivot may be impaired slippery thus making the support unstable. In case of mass-production, the compatibility of the pivot may hardly be guaranteed. The support is pivotally connected to the distal end of the linkage constantly receiving a gravity-moment created by the arm to the overturning direction, and causing fingers to slightly drift from one location to another, then the supported arm needs its nerves and muscles being tensioned continuously.

CB5:support(medium), pivot(medium), detach(poor), RSI(low), rest(void), size(low), durability(low), cost(medium)

C6) The device described in 256 (Gross) supports mainly the palm rather than the forearm, and the platform is located in the front side of a desk. The structure of the arm support is very intricate, and a detachable step of it is also very intricate. A movement of the wrist is very limited, and the platform disturbs using the center drawer of the desk.

CB6:support(poor), pivot(void), detach(void), RSI(poor), rest(poor), size(poor), durability(poor), cost(poor)

C7) The device described in 208 (Bonutti) has a slide member and three pivot joints. Three pivot joints occupy very bulky space, and the clamp of the base to a desk is obsolete, many projections of the device collide with the chair or impair the body of a user or his clothes.

CB7:support(medium), pivot(medium), detach(poor), RSI(low), rest(low), size(poor), durability(poor), cost(poor)

C8) The device described in 064 (Copeland) is installed to the back-side of a desk. Its installation deteriorates the physical strength of the desk, and disturbs the use of a drawer. A detachable step of it is very intricate.

CB8:support(poor), pivot(void), detach(void), RSI(poor), rest(void), size(poor), durability(poor), cost(poor)

C9) The device described in 408 (McAllister) has an arm to a mouse pad, and a mouse support table is adjustably attached to it via an off-center rotational joint. The arm is broken down when receiving the overall weight of the user, and the structure of the arm is very intricate.

CB9:support(void), pivot(low), detach(void), RSI(poor), rest(void), size(low), durability(low), cost(medium)

C10) The system described in 301 (McGrath) has an adjustable, upper body support assembly for keyboard users including a pair of adjustable armrests mounted on a rigid frame. The assembly is positioned adjacent and partially underneath a piece of furniture. The assembly also includes a support frame and an upper body support apparatus. The support apparatus is movably engaged with the frame to permit the apparatus to be moved underneath a piece of furniture when not in use. The support system is very large, required a huge installation space, scrapping the old desk, wasting resources. The armrest has no pivot function, and its cost is very high.

CB10:support(poor), pivot(void), detach(poor), RSI(poor), rest(low), size(poor), durability(low), cost(poor)

C11) The device described in 064 (Hong) has a wrist support to reduce RSI comprising a cushion mounted from an articulated strut so as to be movable about three axes whereby it may yaw, pitch and roll relative to the strut, and a spring to bias the cushion to a neutral pitch and roll position. But the structure based on three axes requires a relatively large complex one, the size of the support under the cushion is large. The articulated strut is a kind of linkage constantly receiving a gravity-moment created by the arm to overturning direction, and causing fingers to slightly drift from one location to another, the supported arm needs its nerves and muscles being tensioned continuously.

CB11:support (medium), pivot(medium), detach(poor), RSI(medium), rest(low), size(low), durability(low), cost(low)

C12) In a data entry operation for 3-D CAD software, its user has to hold and operate a mouse continuously for irregular and complicated motion while its forearm remaining lifted up over two or four hours and may feel fatigue or pain on his arm. Some users for advanced CAD software claim that they feel a kind of fatigue just when watching the mouse. With Its personal computer and keyboard placed together on a desk, the space f or operating the mouse on it should be saved as large as possible. We, the inventors, found through a series of mouse operating actions that the controlling of the mouse is easy for conducting a combination of the translation motion and the angular rotation when the forearm remains held not to move linearly in x-y directions but rotatable for shifting its angular attitude in a system while the wrist is floating freely in all directions.

In summarizing the description in C1 to C12, the RSI problems ever since type-writers and computers were introduced are now focused and their solutions are attempted particularly by manufacturers, distributors, and end users with lots of failures due to multiple reciprocal requests existing in the problems. So far, no convenient devices are provided for fundamentally eliminating the above problems. As the fingers or wrist of a user is generally fixed within a limited range of the space, its movable range is allowed no large spatial freedom by the initial given conditions. Also, as the conventional devices of the prior art are designed for supporting pain-portions of the hand near the wrist, its mechanism is limited by pain-conditions thus narrowing motion of wrists. This will be disadvantageous particularly to the long-acting user.

For example, when user operates an entry means of a computer at a same location and at a same attitude, it may suffer from RSI on his muscles, chords, and nerves. Even when translation motion and rotating movements are permitted by the action of a linkage, the operating position of the hand is only shifted from one location to another on the same horizontal plane, and no attitude changes are derived from action of the linkage. For preventing from drifting largely from their initial operating position, the arm of user have to be tensioned more or less on the upper torso. Accordingly, RSIs remain unsolved. The conventional mechanism for permitting the rotating movements in three degrees of freedom (DOF) is based on the armrest combined with a rotary mechanism for having three independent axes as described in the paragraphs B7 and B11 and its structure becomes very bulky and complex, hence making the installation on the desk difficult.

C13) As a conventional armrest comprises a device for supporting the forearm and a transfer means which are separately provided and assembled not integrally, it needs relatively wider area for installation. Also, as typically described in the paragraph B10, a dedicated set of a desk and a chair for operating a computer is commercially available. When such a new set is obtained, the existing desk is no more needed and may be wasted leading to losses of resources. The dedicated set of desk is unfavorable for use in different applications. The existing desk once used with a conventional armrest exhibits undulations or dents in its upper or side surface and may be found of no use. This will decline the efficiency of utilization of a room where the desk is installed and force the owner of the room to charge a higher fee to a tenant.

### SUMMARY OF THE INVENTION

The inventors have pointed out that a mechanism for physically supporting the forearm of user at its center-of-gravity (while the hand remain substantially floating in the air) is much friendly to movements of the hand. The present invention is developed in view of the above aspects and its object is to provide a pivotal armrest apparatus which is comfortable for operating a keyboard or a mouse, and will invite no RSI-problems when used for a long period of time.

An advantage of the present invention is to provide an armrest in which a pivotal mechanism mounted on an anti-slip member is introduced to provide a soft-rigidity for the pivot motion, and this invites a simple structure, a very comfortable controllability in use, and no RSI-problems.

For the achievement of the object, an armrest apparatus according to the present invention is comprising: a base member detachably mounted on the surface of a table or desk; a cradle means supporting an elbow-side portion of a forearm from the wrist; and

said base member and said cradle means further including a pivotal mechanism formed by directly connecting to each other; and

said pivotal mechanism including a pivotably curved-surface of a predetermined shape, wherein while said forearm is supported by said cradle means, the location and the attitude of said forearm can be controlled in any desired movement by said pivotal mechanism.

For another achievement of the object, an armrest apparatus according to the present invention is provided comprising:

a cradle means supporting an elbow-side portion of a forearm from the wrist;

a pivotal mechanism formed by directly mounting said cradle means on the surface of a table or desk;

an anti-slip member interposed between said cradle means and said surface of a desk; and

said pivotal mechanism including a pivotably curved-surface of a predetermined shape, wherein while said forearm is supported by said cradle means, the location and the attitude of said forearm can be controlled in any desired movement by said pivotal mechanism.

According to the present invention, a method for installing an armrest apparatus on a surface of a desk, said armrest apparatus including a base member detachably mounted on the surface of the desk and a cradle means supporting an elbow-side portion of a forearm from the wrist, the steps of the method comprising:

forming a pivotal mechanism by directly connecting said base member and said cradle means to each other; and,

mounting said base member on said surface of the desk at a desired location.

Our invention will be explained in greater detail in relation to preferred embodiments thereof, as shown in the accompanying drawings.

### BRIEF DESCRIPTION OF THE DRAWINGS

FIG. 1A is a perspective view of an armrest apparatus 1a;

FIG. 1B is a sectional view taken along line X-X of FIG. 1A;

FIG. 1C is a sectional view of surface 83 tilted by an angle of θ.

FIG. 2 is an exploded assembly views of armrest 1a.

FIG. 3A is a plan view of cradle member 8a;

FIGS. 3B and 3C are a side view and a front view of the same;

FIG. 3D is a plan view of engaging means 7a;

FIGS. 3E and 3F are a front view and a side view of the same;

FIG. 3G is a plan view of post member 41;

FIG. 3H is a front view of the same;

FIG. 3J is another plan view of post member;

FIG. 3K is a front view of the same;

FIG. 3L is a plan view of spacer 64;

FIG. 3M is a front view of the same;

FIG. 4A is a plan view of joint member 5a;

FIG. 4B is a front view of the same;

FIG. 4C is a plan view of fitting member 39;

FIG. 4D is a front view of the same;

FIG. 4E is a plan view of cover 29a;

FIGS. 4F and 4G are a front view and a bottom end view of the same;

FIG. 4H is a plan view of platform 22a;

FIGS. 4J and 4K are a front view and a bottom end view of the same;

FIG. 5A is a plan view of armrest 1a with a mounting plate 24.

FIG. 5B is a side view of the same with forearm 114.

FIG. 5C is a perspective view showing the same.

FIG. 5D is a plan view of cradle member 8a located at the frontward end.

FIG. 5E is a side view of the same with forearm 114.

FIG. 5F is a perspective view of the same.

FIG. 6A is a plan view of armrest 1b and

FIG. 6B is a sectional view taken along line X-X of FIG. 6A.

FIGS. 6C and 6D are a side view and an exploded front view of the same.

FIGS. 6E and 6F are a front view and a bottom end view of pivotal mechanism 5b.

FIG. 7A is a plan view of armrest 1c.

FIGS. 7B and 7C are a side view and a front view of the same.

FIG. 8A is an exploded front view of armrest 1c and

FIG. 8B is an exploded side view of the same.

FIG. 8C is a plan view of second transfer means 71c.

FIG. 8D is a plan view of cover 39c for first transfer means 31c.

FIG. 8E is a plan view of joint member 5c.

FIG. 8F is a plan view of anti-slip member 38.

FIG. 8G is a plan view of first transfer means 31c.

FIG. 8H is a plan view of a magnet for transfer means 31c and 71c.

FIG. 8J is a plan view of second runway 81c.

FIG. 8K is a plan view of first runway 21c.

FIG. 8M is a plan view of base member 2c.

FIG. 8N is a plan view of detachable member 26.

FIG. 9A is a sectional view of first transfer means 31c;

FIG. 9B is a sectional view of surface 83 tilted by an angle of θ.

FIG. 9C is a sectional view of joint member 5a having a relatively smaller diameter r and supported by a rotary-sliding mechanism.

FIG. 9D is a sectional view of surface 83 tilted by an angle of θ.

FIG. 9E illustrates a joint member 5j modification that may be belonged to base member 2e.

FIGS. 10A to 10F are sectional views illustrating some variations of the pivotal mechanism between the surface 28 of base member 22 and curved-surface 51 of joint member 5.

FIGS. 10G to 10J illustrate a foldable armrest 1u.

FIG. 10G is a plan view of folded armrest 1u.

FIG. 10H is a sectional front view of non-folded armrest 1u.

FIG. 10J is a sectional side view of folded armrest 1u.

FIGS. 11A to 11C illustrate a modification of an armrest made of wood.

FIG. 11A is a plan view of armrest 1d.

FIGS. 11B and 11C are a front view and a side view of the same.

FIGS. 11D to 11F illustrate a modification of an armrest having a cylindrical curved-surface.

FIG. 11D is a plan view of armrest 1j.

FIGS. 11E and 11F are a side view and a sectional front view of the same.

FIG. 12 illustrates armrest 1v made of a balloon.

FIG. 12A is a sectional view of armrest 1v at a pressurized, expanded state.

FIG. 12B is a sectional view of fluid control means v1 in service state.

FIG. 12C is a sectional view of armrest 1v in a contracted state.

FIG. 12D is a sectional view of valve v1 not in use.

FIG. 13 illustrates a vacuum-suction type detachable member 20v.

FIG. 13A is a plan view of the same.

FIGS. 13B is a plan view and a side view of a suction plate.

FIG. 13C is a side view of detachable member 20v before the suction process.

FIG. 13D is a side view of detachable member 20v after the suction process.

FIG. 14 illustrates a resources-saving type desk-system sys1 where armrest 1a is mounted and dismounted from the near side of a desk.

FIG. 14A is a perspective view of the entire desk-system.

FIG. 14B is a perspective view of the entire desk-system engaged with armrest 1a.

FIG. 14C is an explanatory view showing a hook-like thin plate w4 detachably engaging with a retaining member w2.

FIG. 14D is an explanatory view showing a height control means.

FIG. 14E is a sectional view of the system before accepting thin plate w4.

FIG. 14F is a plan view of the same.

FIG. 14G is a sectional view of the system after accepting thin plate w4.

FIG. 14H is a plan view of the same.

FIG. 15 illustrates a parallel arrangement of a mat implanted with needle-like members 12 bonded on surface 83 and an externally driven rocking mechanism 16.

FIG. 15A is a plan view of armrest 1k.

FIGS. 15B and 15C are a side view and a front view of the same.

FIG. 15D is a sectional view of rocking mechanism 16.

FIG. 16 illustrates an armrest 1h provided with cradle means 9h which has transfer mechanism 7h arranged for rocking movements in forward, backward, upward, downward, leftward, and rightward directions and sliding movement in one direction.

FIG. 16A is a plan view of an entire arrangement of armrest 1h.

FIG. 16B is a sectional view taken along line X-X of FIG. 16A.

FIG. 16C is a side view of the same.

FIGS. 16D and 16E are a side view and a front view of restricting means 67h for height control chain 66h.

FIG. 16F illustrates height control chain 66h for cradle member 8h at a locking state.

### DETAILED DESCRIPTION OF THE PREFERRED EMBODIMENTS

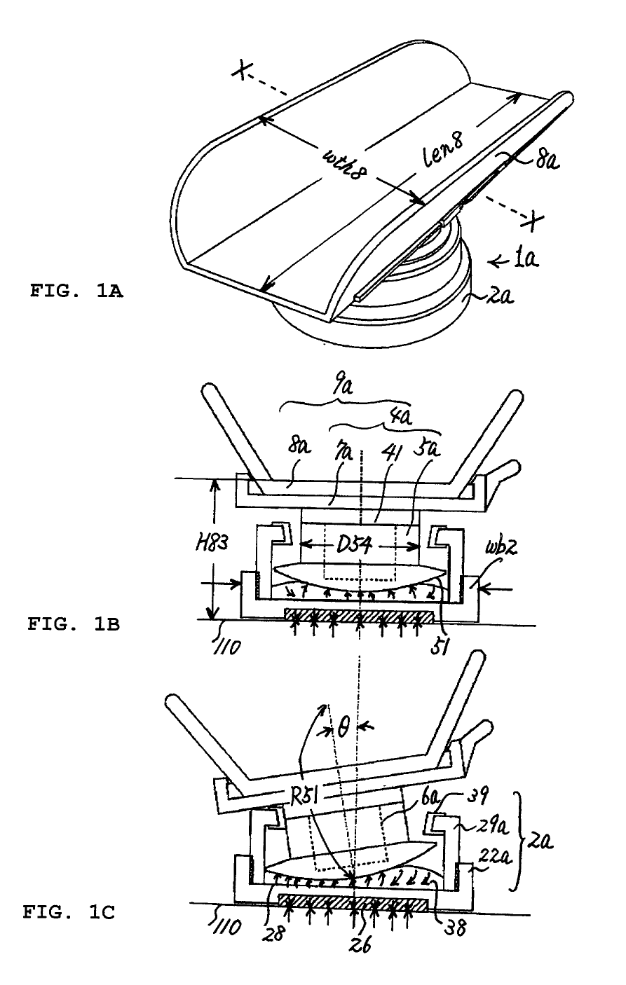

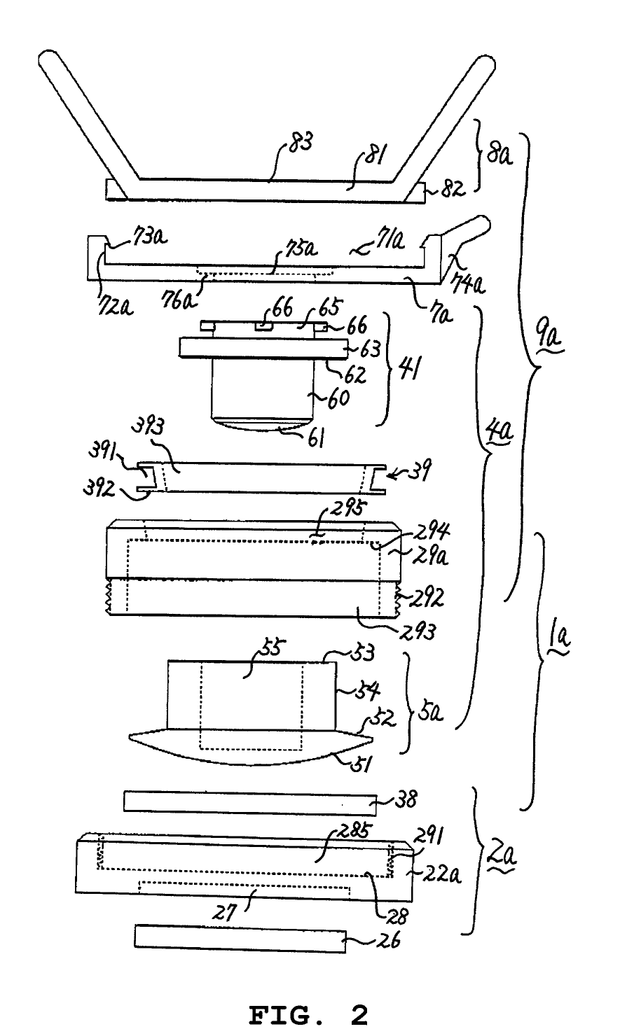

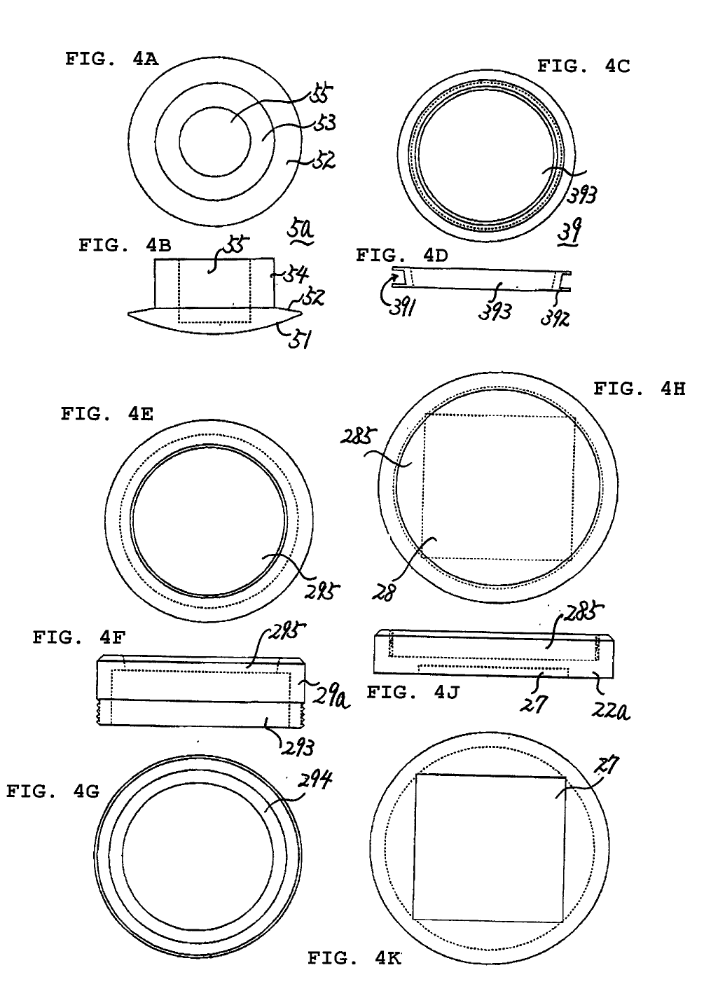

FIGS. 1 to 5 illustrate an embodiment of the present invention, an armrest apparatus 1a which comprises two member, that is, a base member 2a which is detachably mounted on the surface 110 of a table or desk, and a cradle means 9a which is supporting an elbow-side portion of the forearm from the wrist as shown in FIG. 2. The cradle means 9a is associated with the base member 2a to form a pivotal mechanism 5a by connecting directly with each other, and by connecting detachably with each other. Preferably an anti-slip member 38 is interposed between base member 2a and cradle member 9a.

In one preferable association example, cradle means 9a is mounted on base member 2a to form pivotal mechanism 5a, which comprises of a joint member 5a, the anti-slip member 38, and a flat-bottom 28 of base member 2a. In joint member 5a, a pivotably curved-surface 51 is formed at a lower portion of cradle means 9a, and directly mounted on bottom face 28 in an upper recess 285 of base member 2a. The radius R51 of curved-surface 51 (if formed by a part of a sphere) may range from 10 mm to 120 mm, and preferably from 50 mm to 90 mm. An upper or taper surface 52 of joint member 5a is sloped down towards the outer edge (preferably at an angle of 5 to 10 decrees to define the tilting angle of cradle means 9a) and beveled or rounded at the outer edge. Also, surface 52 may be mounted by a shock absorbing material, an elastic material such as urethane resin, or a gel material for absorbing any undesired impact.

Cradle means 9a comprises a support member 4a and a cradle member 8a, and the support member 4a comprises the pivotal mechanism 5a, a rotatable mechanism 6a, and an engaging means 7a. In FIG. 2, support member 4a is included in crafle means 9a. The engaging means 7a is a fore and aft adjusting means of the cradle member 8a, and cradle 8a can be attached to and detached from support member 4a by a lever 74a operation. In cradle member 8a, an engaging portion 82 is formed on the bottom, and fitted into a recess 71a in engaging means 7a.

The rotatable mechanism 6a comprises joint member 5a and a post member 41, where the post member 41 is rotatably fitted at a lower post 60 into a recess 55 formed in joint member 5a. Thus, joint member 5a and cradle member 8a are rotatably connected with each other by rotatable mechanism 6a. Post member 41 is detachably fitted into joint member 5a, detachably fixed to engaging member 7a, and has a height control function in later described.

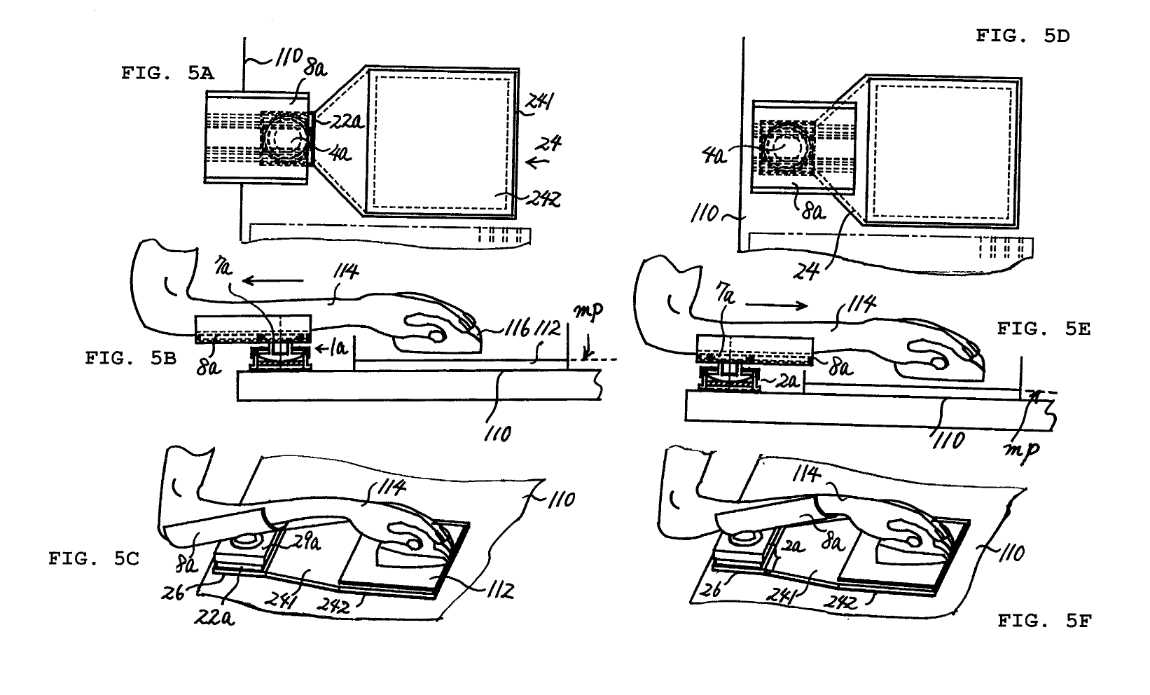

When the forearm of a user operating a mouse or keyboard is mounted on a contact surface 83 of cradle member 8a, it can be supported by the action of cradle means 9a as lifted freely in the air above the moving plane mp (shown in FIG. 5B) on which the mouse is operable. More specifically, the forearm mounted on cradle means 9a can be driven to any desired location (x, y, z) and attitude (α, β, γ) by pivot motion of curved-surface 51 which will be described later in more detail. This allows surface 83 to be moved rotatably and pivotably to vary its height along z-axis. It is preferable in armrest 1a to support the arm from below and the forearm may be held at about the center-of-gravity. More specifically, the forearm is mounted on cradle means 9a at a location distanced about ½ from the elbow (ideally best at the center-of-gravity in view of the dynamics which may hardly be assured on a normal office environments and in practice, preferably at a location distanced ⅕ to ¾ from the wrist, more preferably ¼ to 2/4 from the wrist). It is also preferable that with cradle 9a directly mounted on base member 2a, armrest 1a is detachably adhered or fixed from the above or from the near-side to a desired location on surface 110 of a desk.

Base member 2a in FIG. 2 comprises a platform 22a, a cover 29a, anti-slip member 38 mounted on upper recess 285 of platform 22a, and a detachable member 26 (provided as an anti-slip material, and attached to a lower recess 27 of platform 22a). The detachable member 26 attached to bottom of base member 2a prevents base member 2a or armrest 1a from being overturned, and all of the base members 2a are detachable. Platform 22a may preferably have a round shape or a rectangular shape, including a square, in the cross-section which is easily machined. When platform 22a has finger engaging flat-plane on the outer side, such as of a hexagonal nut, its attachment and detachment as well as positioning can be carried out with much ease. The same effect is gained by forming a knurled region on platform 22a horizontally or vertically.

Detachable member 26 is preferably made of an adhesive material, such as urethane rubber, which is very high in the viscosity and the adhesivity, and more preferably laminated by double-sided tape (having a sheet base coated at both sides with a highly adhesive material ) which can easily be bonded to the bottom at lower recess 27. Detachable member 26 may have a thickness of 1 mm to 15 mm, preferably 2.5 to 6 mm, and more preferably 3 to 5.5 mm.

Platform 22a having a female thread 291 at upper recess 285 is engaged with a male thread 292 on the outer side of cover 29a. Cover 29a has a center opening 295 in the upper side for accepting support member 4a, and a recess 293 in the lower side. A fitting member 39 (made of a ring-like thin elastic material such as urethane resin, and having an annular recess 391 in the outer side) is fitted into center opening 295 for cushioning or attenuating the sound of collision between cover 29a and support member 4a at bottom 392 and opening 393.

While anti-slip member 38 is mounted on surface 28 at the upper recess 285 for preventing joint member 5a from slipping away, cover 29a serves as a restricting means of pivot motion for support member 4a, and further serves as a dust-proof means of pivot motion for anti-slip member 38. Also, when cover 29a has finger engaging flat-plane on the outer side, it can readily be turned by hand for threading in and out along thread 292. The same effect is gained by forming a knurled region on the outer side of cover 29a horizontally or vertically.

Anti-slip member 38 may be made of an adhesive material, such as silicon gel, which is high in the viscosity and the elasticity and shock absorbency. The thickness of anti-slip member 38 ranges from 1 mm to 15 mm, preferably 2.5 mm to 6 mm, and more preferably, 3 mm to 5.5 mm. Anti-slip member 38 of a rectangular shape may fully cover the entire area of bottom 28 at upper recess 285. It is found through experiments that the size of anti-slip member 38 may be shortened to ½ or ⅓ size of curved-surface 51. An anti-slip material, an annular elastic material such as urethane resin, a gel material, or a combination thereof may be interposed between cover 29a and cradle means 9a to attenuate collision noises.

Support member 4a comprises (as a lower section of cradle means 9a) from below, of joint member 5a, post member 41, engaging means 7a having a narrowed joint portion 76a for closely fitting engagement with post member 41. Joint member 5a and post member 41 are detachably joined to each other by rotatably fitting at recess 55. Post member 41 and engaging means 7a are also detachably joined to each other by closely fitting at an engaging opening 75a.

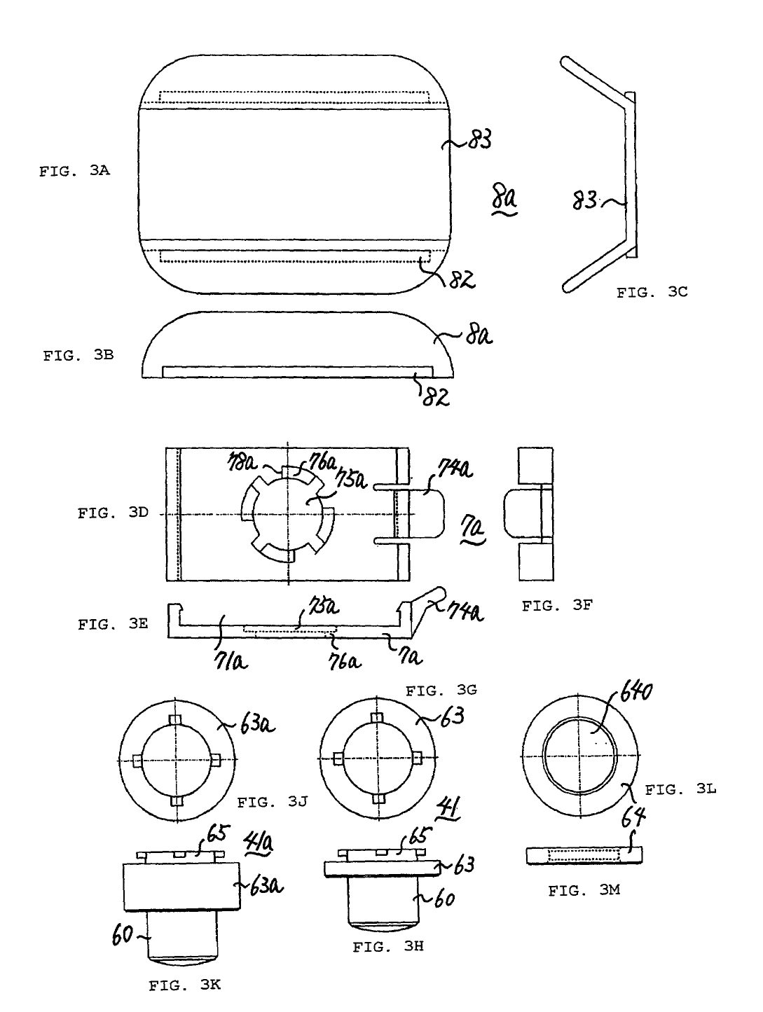

A flange 63 extending radially is formed on the uppermost end of post lower body 60 which has a bottom 61 at the lowermost end. The diameter D54 of flange 63 determines the physical strength of post member 4a and cradle means 9a, and may preferably range from 5 mm to 60 mm, and more preferably 15 to 40 mm. When flange 63 is formed into a hexagonal, or polygonal shape in cross-section, it can easily be held by hand for fitting post member 41 into recess 55. The same effect may be gained by knurling on the outer side of post member 41 horizontally or vertically. The lower side of flange 63, that is sliding surface 62, is slidably joined to upper side 53 of joint member 5a so that they can directly be turned from each other. Flange 63 may be modified for the height control of surface 83 as shown in FIGS. 3H and 3K. As the length of flange 63 is vertically changed or a ring-like spacer 64 in FIG. 3M is mounted on post lower body 60, height H83 (in FIG. 1B) from surface 110 of a table to surface 83 of cradle member 8a can desirably be adjusted. In case that armrest 1a is directly installed on surface 110 for data entry, height H83 is preferably 25 to 70 mm, and more preferably 30 to 60 mm. When armrest 1a is used for medical applications, or mounted on a working table for carrying out a precision work, height H83 is preferably 25 to 250 mm. Height H83 is more preferably 30 to 150 mm for conducting an elaborate work.

At the other end of post member 4a, a group of projections 66 are formed on a post upper body 65 of the same for engagement with engaging opening 75a of engaging means 7a. In FIG. 3D, post member 41 is joined to the narrowed portion 76a by turned counter-clockwisely until it is held with stoppers 78. Cradle member 8a can detachably mounted to engaging means 7a with engaging portion 82 fitted in recess 71a, and the manual opening and closing action of lever 74a enables a fore and aft adjustment of cradle member 8a. The moving mechanism of cradle member 8a may be of either a portal type or a monorail type. As shown in FIGS. 2 and 3, the monorail structure requires less space for installation than the portal structure and will thus be advantageously employed, allowing the upper space of base member 2a to be used effectively.

A base body 81 of cradle member 8a is formed into an arch shape in cross-section and rounded at the corners of both, forward and backward, ends. The upper edges of left and right wings are also beveled or rounded for allowing the forearm moved in an extended range freely. For reducing the weight and improving the ventilation of air of cradle 8a, base body 81 may be perforated to have a multiplicity of tiny holes or surface 83 may be covered with an air-permeable urethane rubber material. Engaging member 7a may be replaced by a slidable transfer mechanism which will be described later. As proved through experiments, engaging means 7a having a relatively higher degree of the resistance to movement is preferably used for typing a keyboard or reading books. When cradle member 8a is longer in the length along x-y axes horizontally than base member 2a or engaging means 7a, armrest 1a will have minimum projections and is improved in the appearance, thus requiring a minimal space for the installation. As engaging means 7a and cradle member 8a are located above support member 4a, a free space is insured between engaging means 7a and surface 110. The free space will hence be utilized effectively. Also, as engaging means 7a is extended horizontally to support cradle 8a, it cooperates with rigid support member 4a to increase the physical strength of cradle means 9a.

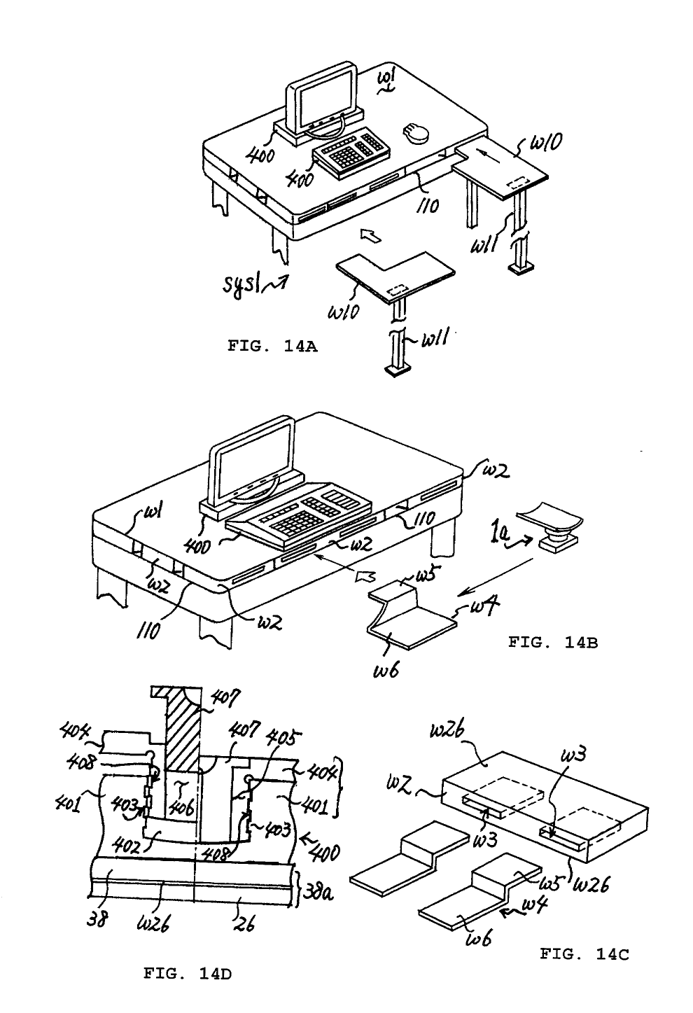

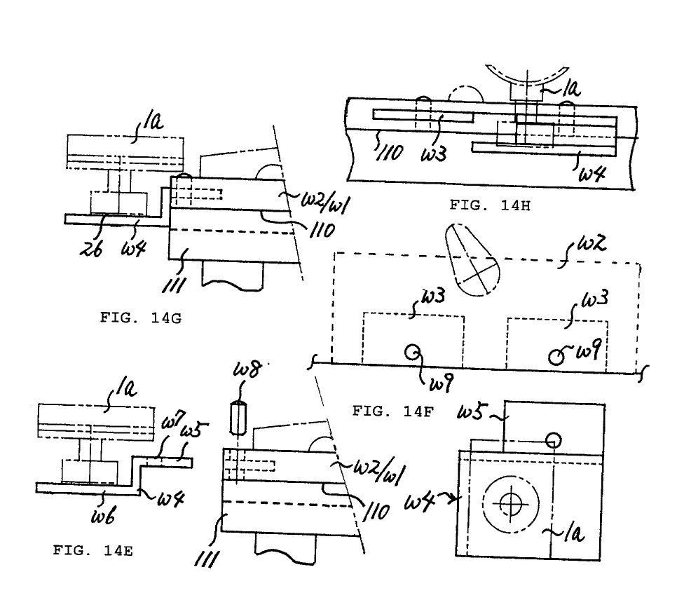

When cover 29a is fitted into upper recess 285, there are provided minimum projections and cradle 8a or engaging means 7a can be in direct contact at its lower side with the upper side of cover 29a, thus increasing the tiltable area of cradle means 9a. Also, when cradle member 8a attached to post member 41 has been removed from recess 55, base member 2a only remains on surface 110 of a desk, hence improves attach and detach operation into one-touch operation of cradle 8a, and the space above base member 2a after dismount of cradle 8a can be used for desirable applications. Detachable member 26 may be made of an anti-slip member for secure installation on surface 110, and can thus be mounted at a desired location on surface 110. Also, detachable member 26 may be layered by a plurality of materials as in FIG. 14D which are different in the adhesivity for adjusting an optimum level of the adhesion according to the characteristics of surface 110. As armrest 1a is mounted on surface 110, it will hardly interrupt the movement of drawers of the desk, collide with a chair, and injure any garment, a set of furniture, or the desk itself. As detachable member 26 is loaded by the weight of the forearm to a vertical direction, armrest 1a is received no overturning moments from the forearm.

In case of dismounting armrest 1a from surface 110, it is very easy, grip base member 2a by hand, then slowly lift it up. That is all.

In view of the degree of freedom (DOF) of arm-motion, armrest 1a of the present invention has discrete and predictable ones. In pivotal mechanism 5a, joint member 5a can be controlled by the pivotably curved-surface 51 in three discrete (first to third) DOFs for 3-D rotations (yawing, pitching, and rolling) at simultaneous operation, hence allowing the forearm to be shifted predictably to a desired position in the height, angle, and direction (whereby RSIs will be eliminated). Also, joint member 5a can be controlled in three discrete (fourth to sixth) DOFs for local translation motion (along x, y, and z axes). Cradle member 8a can be controlled by rotary mechanism 6a (in the seventh DOF) for the rotary movement about z-axis. Moreover, cradle member 8a can be controlled by engaging means 7a for a fore and aft direction along portion 82 (in the eighth DOF).

The action of armrest 1a having the above described DOFs will now be described referring to FIGS. 1 and 5. Illustrated in FIG. 5 is a combination of armrest 1a with the mouse pad/keyboard mounting plate 24, joined to base member 2a by an upper layer 241 (a planer sheet), and bonded with a lower layer 242 (an adhesive material) to surface 110. Plate 24 allows cradle member 8a to hardly detach from or overturn on surface 110. As mounting plate 24 detachably extends from platform 22a, they are securely mounted by adhesive materials 242 and 26 to surface 110. In FIG. 5B, cradle member 8a is adjusted at its backward end of engaging means 7a, and supporting forearm 114 of a user which holds and operates a mouse 116 without overturning. In FIG. 5D, cradle member 8a is adjusted at its forward end of engaging means 7a. As shown in FIGS. 5B and 5E, forearm 114 rested on cradle member 8a is held above the moving plane mp of mouse 116, and travels with mouse 116 running directly on the operating plane mp.

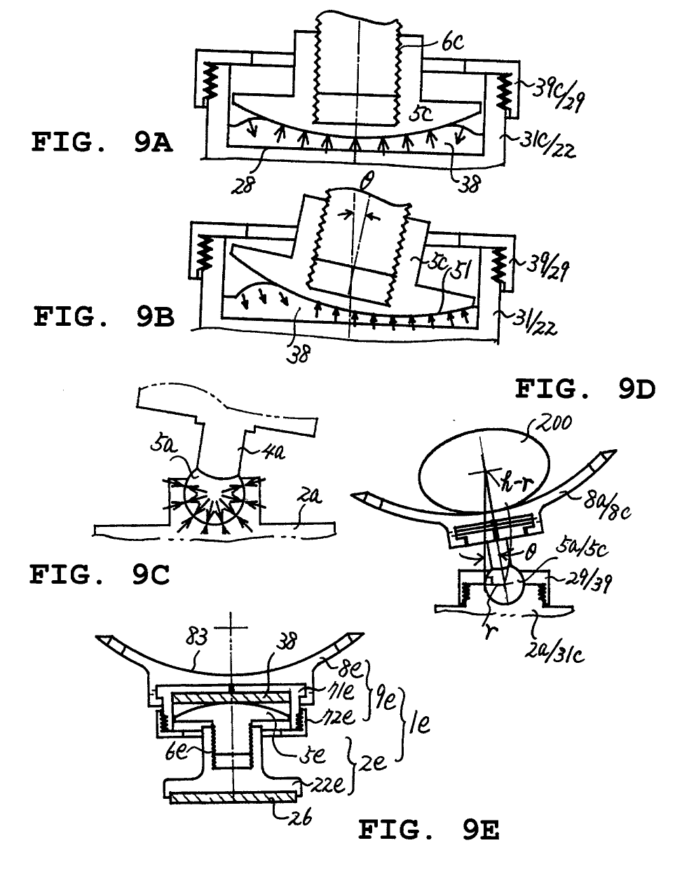

FIG. 9C illustrates a modification of armrest 1a where joint member 5a is directly fitted for pivotal movement in a spherical recess provided in base member 2a. FIG. 9D shows another modification of armrest 1a where joint member 5a is directly fitted in a semi-spherical recess provided in base member 2a. In the latter, joint member 5a is urged at its top from above by cover 29 so that its pivotal movement can be controlled by the pressing force of cover 29. In FIG. 9D, the relation between the radius r of pivot 5a and the height h of forearm 200 rested on surface 83 is examined from the point of the stability of a device. Pivot 5a supporting forearm 200 on surface 83 tilted from the horizontal to an angle θ is shown. If the radius r of pivot 5a <the height h of forearm 200 is applied, the next equation is derived as follows.

r/(h−r)=sin(θ) (1)

so that, the next equiation is gained by equation 1.

r=h/(1+1/sin(θ)) (2)

From equation 2, r=h/6.76 is derived, if θ=10 degree. If the next relation is hold,

r>h/3 (3)

cradle means 9a is very sable. Armrest 1a is small in the size and light in the weight. If joint member 5a increases its radius r greater than diameter D54 of support member 4a, it contributes to improve the durability of armrest 1a. If the next relation is hold on the contrary,

r<h/3 (4)

cradle means 9a has a very vivid operability of the forearm.

In pivotal mechanism 5a of the present invention, anti-slip member 38 is very important as anti-slip materials interposed between joint (universal joint) member 5a and platform 22a for improving the controllability of the forearm, the anti-slip effect, the rigidity of pivot movements and the absorption of unwanted irregular vibrations. A conventional pivot mechanism of ball-socket-joint or the ball-bearings are generally focused on the smooth rotary movements with minimum friction loss. Armrest 1a of the present invention is novel where anti-slip material 38 such as an adhesive material is preferably interposed in the pivotal spaces for adding a resistance force to the pivotal movement thus to control the pivotal motion of cradle member 8a. Accordingly, the irregular wobbling movements of the conventional arm-support (which result in the no-rest use of muscles and nerves for accurately holding the spatial positions of the fingers) can substantially be eliminated and the RSI problems as a user-unfriendly apparatus will be overcome.

Rotary mechanism 6a may have post lower body 60 and its corresponding recess 55 formed by a hexagonal, or any polygonal shape in the cross-section or locked with a key for allowing no rotating movement. In that case, one DOF of armrest motion is lost. Alternatively, when anti-slip member 38 is made of an adhesive material such as silicon gel, cradle means 9a enables the forearm supported thereon to be spun or operated without any trouble due to the soft elasticity of the gel material. More particularly, it is found that the forearm can more comfortably be moved on armrest 1a in data-entry by keyboard when rotary mechanism 6a remains locked or is not provided.

Anti-slip member 38 may be selected at least from adhesive materials, plastics, synthetic resin, resilient materials, rubber adhesive materials containing natural or synthetic rubber, acrylic adhesive materials made by copolymerization of acrylic acid ester and functional monomer, polyether/polyurethane adhesive materials, natural resins such as birdlime, and gel materials such as silicon gel or porous silicon gel, or a combination thereof. In particular, silicon gel or porous silicon gel is preferable as having proper levels of the adhesivity, the rigidity, and the resiliency and provides a vibration-damping effect at armrest 1a. Anti-slip member 38 can easily be cleaned by rinsing with water for repeated use when contact surface with joint member 5a is fouled.

Its preferable example is α GEL (TM of Geltec, Takawana, Minato-ku, Tokyo, Japan). One of the physical properties of a GEL is shown below. The silicon gel comprises:

diorgano-polysiloxane as a green material of the silicon gel (referred to as A component hereinafter) expressed by the formula:

RR12SiO—(R22SiO)nSiR12R (5)

(where R is an alkenyl group, R1 is a monovalent hydrocarbon group having no fatty unsaturated bonds, R2 is a monovalent fatty hydrocarbon group (R2 containing at least 50 mol% of methyl group and, if included, not higher than 10 mol% of alkenyl group), and n is such a numeral that the viscosity ranges from 100 to 100,000 cSt at 25° C.); and

organohydrogen-polysiloxane (referred to as B component hereinafter) as a green material which has a viscosity of not higher than 5000 cSt at 25° C. and contains at least one hydrogen atom bonded directly to two silicon atoms in each molecule.

More specifically, the silicon gel is an addition reaction type silicon polymer generated by curing a mixture of the B component and the A component where the (molar) ratio of the alkenyl group in the A component to the amount of hydrogen atoms bonded directly to silicon atoms in the B component is 0.1 to 2.0.

In a compound structure of the silicon gel, the alkenyl groups R joined to both ends of a molecular chain of the A component are attached to the hydrogen atoms bonded directly to silicon atoms in the B component thus forming a bridge structure. The two alkenyl groups joined to the molecular chain are preferably lower alkenyl groups and more preferably vinyl groups for achieving higher reactivity. The group R1 at the molecular chain is a monovalent hydrocarbon group having no fatty unsaturated bond and may be selected from methyl groups, alkyl groups such as propyl or hexyl groups, phenyl groups, and fluoroalkyl groups.

The group R2 in Formula (5) is a monovalent fatty hydrocarbon group and may be selected from methyl groups, alkyl groups such as propyl or hexyl groups, and lower alkenyl groups such as vinyl groups. R2 however contains at least 50 mol% of a methyl group. When R2 is an alkenyl group, the compound contains preferably not higher than 10 mol% of the alkenyl group. If the alkenyl group exceeds 10 mol%, the bridge structure will be increased in density thus elevating the viscosity. The constant n is carefully adjusted so that the viscosity of the A component at 25° C. ranges from 100 to 100,000 cSt and preferably from 200 to 20,000 cSt.

The B component is a bridging agent for the A component which permits the hydrogen atoms bonded directly to silicon atoms to join with the alkenyl groups in the A component thus curing the A component. While the B component enables to perform the above reaction, its molecular structure may be of a chain form, an annular form, a network form, or any other appropriate form. In the B component, organic groups in addition to the hydrogen atoms are bonded to the silicon atoms and may be a lower alkyl group such as methyl group. Also, the viscosity of the B component at 25° C. is preferably not higher than 5,000 cSt and more preferably not higher than 500 cSt. Characteristic example of the B component are organohydrogen-polysiloxane having a molecular chain closed at ends with triorgano-siloxane groups, a copolymer of diorgano-siloxane and organohydrogen-siloxane, tetraorganotetrahydrogen-chcyclo-tetrasiloxane, a copolymer polysiloxane comprising HR12SiO ½ unit and SiO 4/2 unit, and a copolymer polysiloxane comprising HR12SiO ½ unit, R13SiO ½, and SiO 4/2 unit, where R1 is the monovalent hydrocarbon group having no fatty unsaturated bond. The A component and the B component are mixed and cured so that the ratio of the molar weight of hydrogen atoms bonded directly to silicon atoms in the B component to the molar weight of the alkenyl group in the A component ranges from 0.1 to 2.0 and preferably from 0.1 to 1.0.

The curing process may be carried out using a catalyst. The catalyst is preferably a palladium catalyst and may be selected from finely grained palladium, palladium chloride acid, palladium oxide, complex salt of palladium and olefin, palladium alcoholate, and complex salt of palladium chloride acid and vinyl siloxane. In mixture, the complex salt is not lower than 0.1 ppm (based on palladium as applied to all ppm measurements hereinafter) and preferably not lower than 0.5 ppm in the sum weight of the A component and the B component. The amount of the catalyst has no upper limit. When the catalyst is a liquid or a solution, 200 ppm or lower will be adequate.

As the mixture of the A component and the B component with the catalyst has been left at the room temperature or heated, they are cured to develop the silicon gel used in the present invention. The heating for curing may be carried out at a temperature ranging from 50° C. to 160° C. The silicon gel fabricated by the above manner has a penetration rate of 5 to 250 measured conforming to JIS K2207-1980 at loading of 50 g. The hardness of the silicon gel may vary depending on the characteristics of the bridge structure between the A component and the B component. The viscosity before curing and the penetration rate after curing of the silicon gel can be controlled by doping 5 to 75% by weight of silicon oil having methyl groups at its chain end.

The silicon gel may be either fabricated by the above described manner or purchased in the applicable market. Examples of the commercially available silicon gel include CF5027, TOUGH-3, TOUGH-4, TOUGH-5, TOUGH-6, TOUGH-7, and TOUGH-8 (of Toray Dow Coning Silicon), X32-902/cat1300 and KE1308/cat1300-L4 (of Shinetsu Chemical), and F250-121 (of Nippon Unica).

Also, other agents than the A component, the B component, and the catalyst may be doped such as a pigment, a retardant, a flame-retardant, or an electrically conductive filler without impairing the desired properties of the silicon gel. Furthermore, the silicon gel may be doped with a filler of minute hollow spherical forms for increasing the effect of anti-vibration and anti-impact. Characteristic examples of the filler are Fillite and Expansel (TM of Nippon Ferrite), and Matsumoto Microsphere (TM of Matsumoto Yushi).

The driving force for the pivotal movements of cradle means 9a may be adjusted by controlling the adhesivity of anti-slip member 38 itself. The driving force for the pivotal movements between cradle means 9a(or joint member 5a) and base member 2a(or platform 22a) may be adjustable by changing the contact area-size and thickness of anti-slip member 38 or by modifying the accuracy of the surface finishing on curved-surface 51 or bottom 28. The higher the accuracy of the surface finishing such as mirror finishing, the greater the adhesivity of anti-slip member 38 is increased as compared with wooden materials of which the surface is highly undulated. Anti-slip member 38 as an adhesive material may offset variations in the finishing accuracy on the undulated or planer surfaces or in the assembly accuracy of the components. Even when the contact curved-surface 51 against bottom 28 is finished with the surface at a lower accuracy or assembled by bonding or abutting two crescent blocks finished at a lower accuracy, its unfavorable surface roughness may be absorbed by anti-slip member 38 of 1 mm to 15 mm thick. Accordingly, the use of anti-slip member 38 is preferable for providing the smooth pivotal movement, hence contributing to the lower cost of armrest 1a.

Detachable member 26 as an anti-slip material for the entire structure of the armrest apparatus 1a may also be made of the same material as of anti-slip member 38 or the like. For providing a higher level of the adhesivity to secure the entire body to surface 110 of a desk, the material of detachable member 26 is preferably a urethane rubber material, a vacuum suction member, or a magnetic material. Examples of the urethane rubber material are G-Base-2, and G-Base-Sheet (TM of G-Base Osaka, Japan). Particularly, G-Base-2 has a higher level of vibration absorbing capability at a small thickness while being very light in the weight.

One of the physical properties of G-Base-2 is shown below. The urethane rubber material comprises:

a polyurethane elastomer is mixed with from 1% to 60% by volume of a minute hollow spherical materials, the mixture exhibits not smaller than 80% in the shock absorption rate, from 0.5 kg/cm² to 1.84 kg/cm² in the adhesivity, and from 0.4 g/cm³ to 1 g/cm³ in the specific gravity. The minute hollow spherical materials in the polyurethane elastomer are depressed and rebound repeatedly, like the action of a balloon, when urged by an external stress due to vibration or impact. This improves the impact absorbing capability and even when the thickness is decreased, its impact absorbing capability will not be declined. The vibration absorbing capability along z-axis will significantly be improved. Also, as the specific gravity is decreased, the overall weight will decrease. While the detachable member 26 itself has a level of adhesivity, it requires neither any other bonding agent nor double-sided tape for bonding between the assembly and the table or desk, hence decreasing the number of steps as well as the overall dimensions and weight. When its minute hollow spherical material ranges from 10 μm to 100 μm in the diameter and from 0.01 g/cm³ to 0.1 g/cm³ in the specific gravity, the impact absorbing material of a reduced thickness remains high in the impact absorbing capability and will be favorable for reducing the overall weight. When the ASQR F scale ranges from 30 to 80, the impact absorbing capability on a semiconductor circuited board or the like will be ensured.

The polyurethane elastomer is of no limitation and may be a combination of polypropylene glycol and isocyanate ester doped with phthalic dioctyl. Most preferable is a viscous, elastic urethane rubber (G-Base-2) fabricated by doping a neutral urethane elastomer with a hardener to form a semi-bridge structure. The minute hollow spherical material is also of no limitation and may be selected from a non-organic group of glass balloon, silica balloon, silane balloon, carbon balloon, alumina balloon, and zirconium balloon and an organic group of phenol balloon and vinylidene chloride balloon. One of the most preferable materials is fabricated by doping a thermoplastic resin, such as vinylidene chloride or acrylonytryl, with an expander such as hydrocarbon and heating the mixture to soften the thermoplastic resin and evaporate the hydrocarbon for expansion (for example, Expansel, TM of Nippon Ferrite), which is small in the specific gravity and the weight and high in the impact absorbing capability.

The average size of the minute hollow spherical materials ranges preferably from 10 μm to 100 μm in diameter. More preferably, the upper limit may be 70 μm while the lower limit may be 30 μm. If the size is smaller than 10 μm, the minute hollow spherical material which repeats expansion and contraction like the action of a rubber balloon in the polyurethane elastomer may be declined in the impact absorbing capability. If the size is greater than 100 μm, the impact absorption capability may be declined at an increased thickness. The specific gravity of the minute hollow spherical material ranges preferably from 0.01 kg/cm³ to 0.1 g/cm³ More preferably, the upper limit may be 0.07 g/cm³ while the lower limit may be 0.02 g/cm³. If the specific gravity is smaller than 0.01 g/cm³, the physical strength will be declined. When mixed with the polyurethane elastomer, the minute hollow spherical material becomes susceptible to fracture. If the specific gravity exceeds 0.1 g/cm³, the weight will hardly be decreased.

The dosage of the minute hollow spherical material to the polyurethane elastomer ranges preferably from 1% to 60%by volume. The upper limit of the dosage may be preferably 55% and more preferably 52%. The lower limit may be 5% and more preferably 10%. If the dosage is lower than 1%, the impact absorption capability will be too low. If the dosage exceeds 60%, the production cost will increase and the mixing process with the polyurethane elastomer will be difficult. The impact absorption capability is preferably not smaller than 80% and more preferably 90% or higher. If smaller than 80%, the vibration absorbing capability will be too low. The adhesivity ranges preferably from 0.5 kg/cm² to 1.84 kg/cm² and more preferably from 1 kg/cm² to 1.84 kg/cm².

If the adhesivity is smaller than 0.5 kg/cm², the armrest apparatus may hardly be secured. If over 1.84 kg/cm², the armrest may be detached with difficulty once secured and its handling will be troublesome. The specific gravity ranges preferably from 0.4 g/cm³ to 1 g/cm³. If smaller than 0.4 g/cm³, the ratio of the minute hollow spherical material to the polyurethane elastomer may be too high to be mixed up. If over 1 g/cm³, it may hardly be decreased in the weight. The hardness of the impact absorbing material ranges preferably from 30 to 80 in the ASQR F scale. If smaller than 30, the material may be too soft to be cleaned off and its handling will be troublesome. Also, the impact absorbing capability may be declined. If the material exceeds 80 in the hardness, it may be too stiff to maintain its impact absorbing capability to a desired level.

The impact absorbing material may be fabricated by the following method. The method starts with doping the hardener for polyurethane elastomer with a desired amount of the minute hollow spherical material and mixing the minute hollow spherical material doped hardener with a main material. After the mixture is shaped to a sheet form of a desired thickness, it is maintained at an appropriate temperature (e.g. 70 to 90° C.) for a predetermined length of time (e.g. two to four hours). As having been cured, the mixture is turned to an impact absorbing material.

The impact absorbing material is used as anti-slip member 26 for adhering or securing armrest 1a to the desk. This allows armrest 1a to be also detached with ease. The other components than the adhesive members of armrest 1a may be made of a flexible material or an elastic material.

As shown in FIGS. 1B and 9A, the forearm is supported by surface 83 held horizontally with pivotal mechanism 5a where anti-slip member 38 is urged downwardly by curved-surface 51 so that its center is slightly sunk lower than its edge portion. Simultaneously, a counter force from anti-slip member 38 to curved-surface 51isconcentricallyappliedforbalancing. While curved-surface 51 concentrically receives the counter force from anti-slip member 38, unwanted vibrations transmitted from the forearm can be absorbed by anti-slip member 38 made of a gel material such as silicon gel. As shown in FIG. 1B, detachable member 26 at the bottom of armrest 1a receives uniform counter forces from surface 110 of the desk as denoted by the arrow-marks and remains in a balance.

When surface 83 with the forearm is tilted at an angle θ from z-axis as shown in FIG. 1C, pivotal mechanism 5a causes curved-surface 51 to urge the left half of anti-slip member 38. Accordingly, the left half of anti-slip member 38 is narrowed by the pressure while the right half expands upwardly. As the elasticity of anti-slip member 38 urges curved-surface 51 to return to its original position shown in FIG. 1B, it constantly acts as a light braking or correcting force via curved-surface 51 against all the 3-D angular rotations of the forearm on surface 83 including pivoting or twisting motions (while the predictable control of yaw, pitch, and roll motion can be ensured by pivot 5a).

Also, the elasticity consistently develops a restoring force for returning back to the original horizontal position, hence giving a level of stability and rigidity. Anti-slip member 38 made of the gel material such as silicon gel provides a motion follow-up capability due to its fluidity, thus increasing the predictable operability in the local translation motion or revolution motion. As the gel material is highly elastic, its action can successfully absorb unwanted irregular movements of the forearm. As shown in FIG. 1C, detachable member 26 bonded to the lower surface of platform 22a receives a uniform counter force along z-axis, which is substantially equivalent to the counter force shown in FIG. 1B.

Accordingly, the pivotal mechanism 5a automatically converts with the anti-slip member 38 from the irregular movements of fingers (i.e. typing a keyboard) into stress releasing movements over the forearm without impairing a specific part of the wrist, whereby RSI can hardly be invited on the upper torso, nerves, and muscles. Also, anti-slip member 38 gives a proper degree of rigidity to pivotal mechanism 5a, this allows no drifting of the fingers, improves the repeatability of the finger position, and provides a comfortable rest means. While anti-slip member 38 and detachable member 26 are identical to each other in the properties of their material, they needs different functions. It is hence desired that the material of anti-slip member 38 is relatively high in the fluidity for ensuring a level of the follow-up capability to the movements of the forearm as well as exhibits favorable characteristics for offsetting errors in the production or assembly accuracy and absorbing unwanted irregular vibrations during the movement. On the other hand, detachable member 26 is preferably high in the adhesivity for increasing the anti-slip effect while having a desired level of the vibration absorbing capability.

A modification of the embodiment of the present invention may be provided, as shown in FIG. 14D, where platform 22a is replaced by platform 400 and two adhesive members 38 and 26 are replaced by a single adhesive material 38a layered by joining two or more adhesive or elastic materials, which are equal or different in the adhesivity, into a lamination or layer assembly, thus minimizing the number of relevant components.

Another embodiment of the present invention will be described in the form of a kit of the armrest apparatus 1a. The kit comprises base member 2a detachably installed on surface 110 of a desk, a cradle means 9a for supporting the forearm of a user, an anti-slip member 38 interposed in a pivotal space between base member 2a and cradle means 9a, and a detachable member 26 detachably bonded to the bottom of base member 2a. Base member 2a of the kit can be separated into a platform 22a and a cover 29a. Cradle means 9a of the kit can also be separated into a support member 4a and a cradle member 8a, and support member 4a of the kit can further be separated into a joint member 5a, a post member 41 and an engaging means 7a.

The components of the kit 1a can be assembled in the following steps. The assembly method includes picking up platform 22a from the kit (step D1), mounting anti-slip member 38 on the upper recess of platform 22a (D2), connecting directly joint member 5a with base member 2a (D3), and joining thread between cover 29a and platform 22a (D4). After the steps of rotatably fitting engaging means 7a of upper support member 4a with joint member 5a (D5) and fitting or engaging cradle member 8a with engaging means 7a (D6). From step D1 to D6, pivotal mechanism 5a is formed by directly connecting to base member 2a and cradle means 9a.

After the steps of bonding detachable member 26 at one side to the bottom of platform 22a (D7), and mounting the other side of detachable member 26 on the surface of a desk (D8), the assembly process is completed. From step D7, the assembly of armrest 1a is completed, and from step D8 the installation of armrest 1a is completed.

In case of dismounting armrest 1a from surface 110, it is very easy, grip base member 2a by hand, then slowly lift it up. That ia all.

The components of the kit 1a can be assembled in another following steps. The assembly method includes picking up platform 22a from the kit (step E1), bonding detachable member 26 at one side to the bottom of platform 22a (E2), and mounting the other side of detachable member 26 on the surface of a desk (E3). The steps follow mounting anti-slip member 38 on the upper recess of platform 22a (E4), engaging or mounting joint member 5a on anti-slip member 38 (E5), and thread joining between cover 29a and platform 22a (E6). After the steps of rotatably fitting engaging means 7a of upper support member 4a with joint member 5a (E7) and fitting or engaging cradle member 8a with engaging means 7a (E8), the second assembly method of armrest apparatus 1a is completed.

Another installation of armrest apparatus 1a will now be described.

F1) When armrest 1a is available in its assembled form, the following procedure is conducted before delivery.

The procedure (E1, E2, and E4 to E8) includes mounting cradle means 9a, which includes a cradle member 8a on which a portion close to the wrist of the forearm of a user is held, directly on base member 2a, which is detachably installed directly on the surface of a desk, with a pivotal mechanism 5a, which is pivotable along the curved-surface of a predetermined shape, provided between cradle means 9a and base member 2a so that the forearm can be varied in the height along z-axis by the action of cradle means 9a while controlled for pivotal movements by pivot 5a. At the time, detachable member 26 remains covered at one side with a protective sheet.

As armrest 1a is received by the user and exposed at the bottom by removing the protective sheet from the side of detachable member 26, it is installed on the surface of a desk with detachable member 26 bonded by the adhesivity to a desired location of the surface (E3 of the above described steps). Then, the installation of armrest 1a is completed.

F2) When armrest 1a is available in the form of a kit which has to be assembled by a user, the following steps are needed.

The steps include picking up platform 22a from the kit (E1), after removing a protective sheet from detachable member 26, bonding detachable member 26 at one side to the bottom of platform 22a (E2), and after removing another protective sheet from detachable member 26, bonding the other side of detachable member 26 to the surface of a desk (E3). A preparatory procedure for directly installing base member 2a at a desired location on the surface of a desk is now completed.

The steps then follow, after removing protective sheets from both sides of anti-slip member 38, mounting anti-slip member 38 on the upper recess of platform 22a (E4), further mounting joint member 5a on anti-slip member 38 (E5), and thread joining between cover 29a and platform 22a (E6). After the steps of rotatably fitting engaging means 7a of upper support member 4a with joint member 5a (E7) and fitting or engaging cradle member 8a with engaging means 7a (E8), the assembly procedure of armrest 1a is completed.

Accordingly, cradle means 9a is directly mounted on base member 2a to form directly pivotal mechanism 5a along curved-surface 51 of a desired shape, whereby the forearm rested on cradle member 8a can be varied in the height along z-axis and controlled for pivotal movement by the action of cradle means 9a.

F3) The steps described in F1 and F2 for directly mounting cradle means 9a onto bottom 28 of base member 2a may preferably be added with a step of providing an anti-slip member 38 between cradle means 9a and base member 2a. Anti-slip member 38 may be selected from at least an adhesive material, a synthetic resin material, an elastic material, a synthetic or natural rubber material, a gel material, a silicon gel material, and a porous silicon gel material. Preferably, the material of anti-slip member 38 is an adhesive material or namely a silicon gel material. Also, detachable member 26 is provided on the bottom of base member 2a for ease of detachably installing armrest 1a on the surface of a desk. Cradle means 8a may detachably be joined to engaging means 7a of upper support member 4a. More specifically, cradle means 8a is detachably inserted, fitted, abutted, or assembled at engaging projections 82 with engaging means 7a for forward and backward movement to adjust its position. Moreover, engaging means 7a of support member 4a is detachably joined by rotary mechanism 6a of post member 41 to joint member 5. This allows cradle means 9a to be adjusted in the height by changing a vertical length of post member 41. Alternatively, a slidable engaging means (as shown in FIG. 14D) may be provided on post member 41 for adjusting the height of cradle means 9a.

Cover 29a having a through opening 295 provided in the upper side thereof and acting as a restricting means for restricting the pivotable range of cradle means 9a may be thread joined by a pair of threads 291 and 292 to platform 22a of base member 2a. An shock absorber member made of a gel material, an urethane material, or an elastic material may also be attached to the inner side of cover 29a where it touches joint member 5a or outer side 52 of joint member 5a for attenuating the sound of collision between cover 9a and joint member 5s.

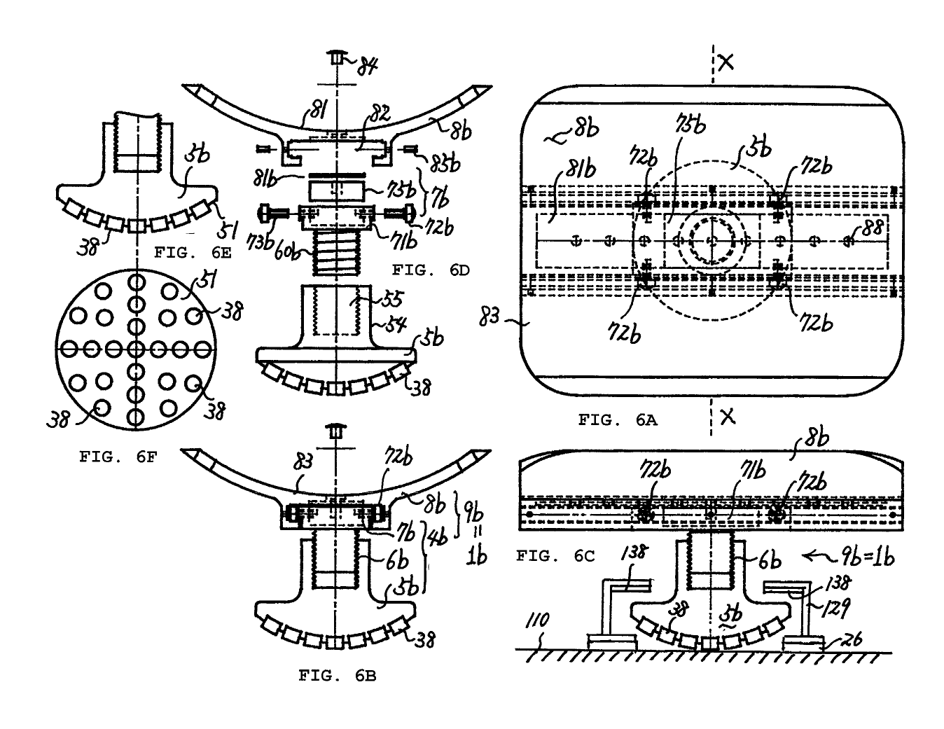

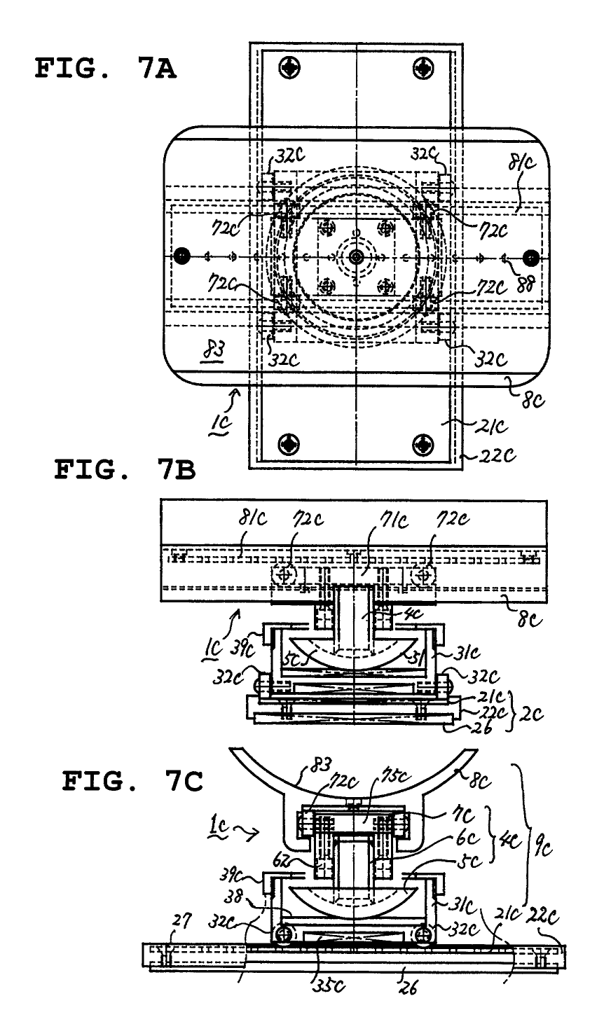

FIG. 6 related to FIG. 2 illustrates another armrest apparatus 1b according to the present invention where a cradle means 9b is mounted directly on a desk with the use of no base member, and a cradle member 8b is accompanied with a slidable (transfer) mechanism 7b arranged rotatable and slidable in one direction. While like components are denoted by like numerals as those of the previous embodiment, transfer mechanism 7b may comprise permanent magnet 75b and rollers 72b for joining with cradle member 8b. As illustrated, armrest 1b comprises a smaller number of the components and can be controlled for pivotal movements and sliding movement. More particularly, armrest 1b comprises a support member 4b and cradle member 8b. Support member 4b incorporates a pivotal mechanism 5b, a thread mechanism 6b, and a transfer mechanism 7b. Cradle means 9b has an angular control mechanism which comprises pivotal mechanism 5b of curved-surface 51 and rotary mechanism 6b.

The construction of armrest 1b of the present invention will be described in more detail referring to FIG. 6. Armrest apparatus 1b comprises cradle means 9b which includes cradle member 8b accompanied with transfer mechanism 7b for transferring the forearm and cradle member 8b linearly, and the angular control mechanism of pivot 5b and rotary thread 6b. Support member 4b inplanted anti-slip member 38 at curved-surface 51 is directly mounted on surface 110 of a desk for pivotal movements. The pivotable range of cradle means 9b may be restricted by a restricting means 129 which is detachably mounted by a detachable member 26 on surface 110. Support member 4b and cradle member 8b are engaged with each other by transfer mechanism 7b acting as a linear transfer mechanism for sliding movements of cradle 8a. Accordingly, the location and angular attitude of the forearm while supported in the air by cradle means 9b can be controlled for pivotal movements and translation motion to operate a mouse or keyboard. As no base member is provided on surface 110, support member 4b is directly mounted at its lowermost end to surface 110.

The construction of cradle means 9b will be explained in more detail. As support member 4b shown in FIG. 6 comprises joint member 5b, thread mechanism 6b also serving as a rotary mechanism, and transfer means 71b for slidably moving cradle member 8b in substantially forward and backward directions, it acts as an angular control mechanism for controlling the angular attitude of cradle means 9b. Support member 4b and cradle member 8b are detachably joined to each other by transfer mechanism 7b. As shown in FIG. 6, joint member 5b as a lower section of support member 4b has a plurality of anti-slip members 38 provided on curved-surface 51 and is hence mounted by anti-slip members 38 on surface 110 of a desk. Another embodiment of anti-slip member 38 related to support member 4b is explained later in FIG. 1C.

While joint member 5b also has cylindrical recess 55 provided in an upper side thereof, a female thread is provided at recess 55 for thread engagement with a male thread provided in a lower portion of transfer means 71b. The threads constitute thread mechanism 6b which acts as a rotary mechanism for turning cradle member 8b, and a height control mechanism for adjusting the length of support member 4b, equivalent to the height of surface 83 of cradle member 8b. As transfer means 71b with the male thread is mounted on the upper end of support member 4b for linearly transferring cradle member 8b, it is also provided at its four locations (front, rear, left, and right sides) to transfer wheels 72b by appropriate tightening means 73b such as eccentric screws. Transfer means 71b has a recess provided in the upper side thereof where a high coercive magnetic material 75b is accommodated by adhesion.

Cradle member 8b has a recess 82 of a C-shape in cross-section provided in the lower side thereof for engagement with transfer means 71b. This allows cradle member 8b can slide linearly over transfer means 71b. More particularly, a shallowly recessed transfer runway 81b is provided at recess 82 in the lower side of cradle member 8b. A strip of high coercive magnetic guiding material is accommodated in transfer runway 81b and tightened to the lower side of cradle member 8b by tightening screws 84 inserted from surface 83. As best shown in FIG. 6D, the head of each eccentric screw 73b acts as a jogging preventing guide for transfer wheels 72b along recess 82 so that cradle member 8b can travel without largely dislocating in the leftward and rightward directions. Alternatively, for preventing cradle member 8b from dislocating in the longitudinal direction while running on transfer wheels 72b, guiding recesses for transfer wheels 72b may be provided in the guiding material in transfer runway 81b or steps may be formed between recess 82 and transfer runway 81b.

Accordingly, transfer runway (the guiding material) 81b and transfer means 71b constitute in a combination linear slidable transfer mechanism 7b. Also, magnetic force of transfer means 71b for attracting transfer runway 81b may be controlled by varying the surface area of magnetic material 75b or the distance between transfer runway 81b and magnetic material 75b, e.g. changing the diameter or the location of transfer wheels 72b. The guiding material in transfer runway 81b is tightened to the lower side of cradle member 8b by tightening members 84 from surface 83 side. When tightening members 84 extend into recess 82, they can act as restricting means for transfer means 71b. When the guiding material in transfer runway 81b has lock holes 88 provided at equal intervals therein, lock pin can be inserted from surface 83 side into lock holes 88 to lock the sliding movement of cradle member 8b. It is also possible for locking the sliding movement of cradle member 8b to use lock pin 85b for inserting into lock holes formed in both sides of transfer means 71b across corresponding holes formed in the lower part at recess 82. Lock means of transfer mechanism 7b comprises lock holes 88 and lock pin 85b.

Accordingly, while cradle member 8b guided with transfer runway 81b is coupled to transfer means 71b by gravity of the forearm and attraction-force of magnetic material 75b, it can slide and travel on transfer wheels 72b of transfer means 71b. Linear transfer mechanism 7b may be replaced with a slide rail mechanism (FBW2560R, TM of THK, Shinagawa Tokyo, Japan), non-contact transfer mechanism such as air slider system, or any other appropriate mechanism when desired.

Armrest apparatus 1b having cradle means 9b arranged rotatable and pivotable with slide traveling (transfer) mechanism 71b allows the forearm of a user supported in cradle member 8b to be arbitrarily controlled by the action of curved-surface 51 in three or more DOFs, particularly so that the height of surface 83 can be changed, while remaining held from below by the action of cradle means 9b, and smoothly transferred longitudinally by the action of transfer wheels 72b of transfer means 71b. When cradle means 9b is not in service, it can easily be dismounted and removed. Anti-slip member 38 may be selected from at least a group of an adhesive material, a synthetic resin material, a synthetic rubber material, a natural rubber material, and a gel material. Its material is preferably a synthetic rubber material such as urethane resin.

A modification of armrest 1b will be explained referring to FIG. 6C where the pivotable range of cradle means 9b directly installed on surface 110 of a desk is restricted by restricting means 129 bonded with detachable member 26 to surface 110. In action, restricting means 129 bonded with a shock absorbing material 138 to inside is in direct contact with the pivotal surface of cradle means 9b thus to restrict pivotal movement of the same. This permits armrest 1b to serve as a comfortable rest means with the adhesion of detachable member 26 when a user feels tired and stops its action after a long period of working. As cradle means 9b is held at a desired angular attitude by the effect of restricting means 129, it supports the forearm at higher stability. Accordingly, cradle means 9b can successfully be controlled for spatial positioning at rest period with no use of muscles or nerves. Also, while armrest 1b is rigid enough to sustain the weight of a user, the conventional armsupport which has a known linkage for holding a cradle may be unstable or wobbled along the horizontal direction and hardly used as a comfortable rest means even if the user feels fatigue after a long period of operations but with need of muscles or nerves for controlling the drifting motion in a given space, hence being unfavorable for conducting the fatigue-free operation.

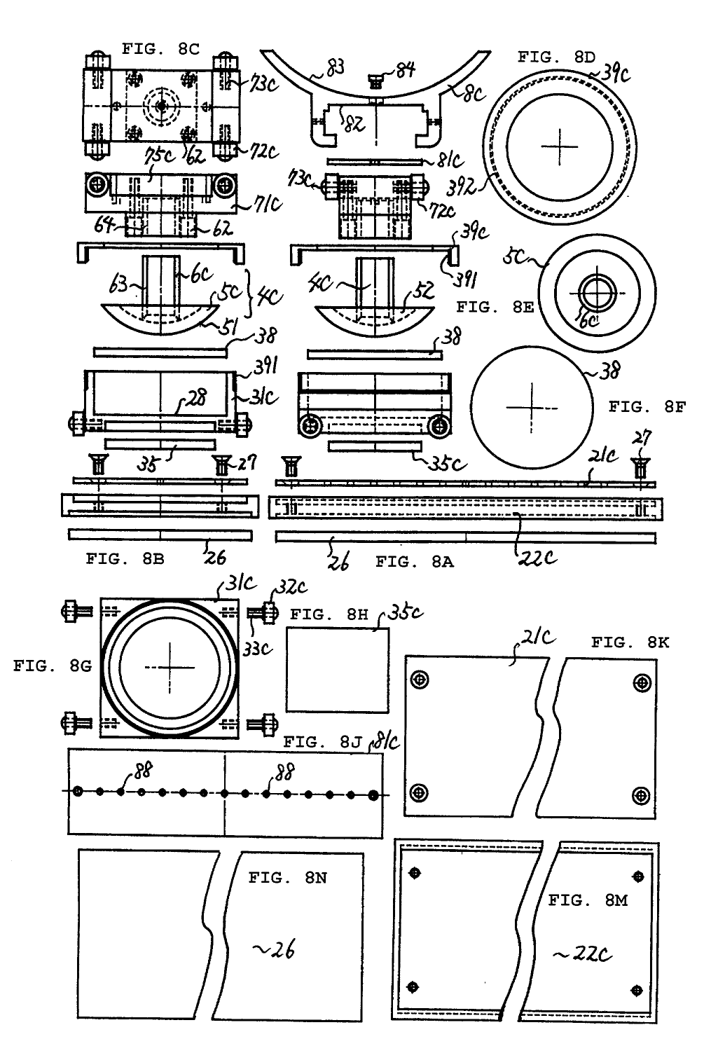

FIGS. 7 and 8 related to FIGS. 2 and 6 illustrate an armrest apparatus 1c according to the present invention where a cradle means 9c has two linear transfer mechanism arranged slidable in two different directions. Like components are denoted by like numerals as those of the previous embodiment. In particular, first transfer mechanism 3c and second transfer mechanism 7c are coupled to each other rotatably and pivotably. Also, runway 21c is short enough to hold armrest 1c at each side. Armrest 1c comprises base member 2c and cradle means 9c. Cradle means 9c consists mainly of, from below, first transfer mechanism 3c, pivotal mechanism 5c, rotary mechanism 6c, second transfer mechanism 7c, and cradle member 8c. Pivotal mechanism 5c and rotary mechanism 6c of cradle means 9c constitute an angular control mechanism in a combination.

The arrangement of armrest 1c is explained in more detail. Armrest 1c comprises mostly first runway 21c elongated longitudinally on base member 2c which is detachably mounted on surface 110 of a desk and cradle means 9c arranged movable with running wheels (rollers) 32c along first runway 21c. Cradle means 9c consists mainly of first transfer mechanism 3c of a roller-type also acting as a linear transfer mechanism including a transfer means (carriage) 31c for linear movement, joint member 5c having curved-surface 51 thereof mounted on bottom 28 of first transfer means 31c for pivotal movement, support member 4c including rotary or thread mechanism 6c and transfer means (table) 71c, and cradle member 8c having second transfer mechanism 7c with a runway 81c slidably carried on transfer table 71c. Armrest 1c allows the forearm of a user mounted on cradle member 8c to be controlled by the action of cradle means 9c for pivotal and rotary movements and sliding movements in leftward, rightward, forward, and backward directions.

First runway 21c shown in FIG. 7 is combined with first transfer means 31c, support member 4c, and cradle means 9c including cradle member 8c. In case that two hands of a user are used, two sets of armrest Ic may be provided at left-side and right-side for positioning with different angles. Alternatively, runway 21c may be joined with two or more of cradle means 9c. In action, while the forearm mounted on cradle member 8c is pivotably held in a given space for operating a mouse or keyboard, it can arbitrarily be changed in the height with pivot operation of cradle means 9c in three or more DOFs over curved-surface 51 to determine its location (x, y, z) and angular attitude (α, β, γ).

Each section of armrest 1c is explained in more detail. Base member 2c arranged detachable has a platform 22c of a long narrow, plane-like form elongated longitudinally on surface 110 of the desk, as shown in FIG. 7. Detachable member 26 is attached or bonded as an anti-slip means to the bottom of platform 22c so that base member 2c can directly be bonded or mounted on surface 110. The location of base member 2c on surface 110 may preferably be at an intermediate between the location of data entry device and the location of a user. First runway 21c of a magnetic material is accommodated in a recess provided in the upper side of platform 22c to elongate longitudinally and tightened at both ends to platform 22c by tightening members 27. Transfer means 31c with rollers 32c secured by eccentric bolts 33c is slidably mounted on runway 21c. As shown in FIG. 7B, running wheels 32c are guided with the side walls at the recess of platform 22c for diminishing or minimizing the forward and backward dislocation of transfer means 31c which travels in the leftward and rightward directions. Runway 21c and transfer means 31c thus constitute linear transfer mechanism 3c of a roller-type.

First transfer means 31c movable longitudinally is arranged of a four-sided box-like shape having a lower recess provided in the lower side thereof corresponding to runway 21c. First transfer means 31c also has an upper recess of a round shape provided in the upper side of a cylindrical portion thereof. Cover 39c having a through opening provided in the center thereof is mounted by threading onto the cylindrical portion of first transfer means 31c. Four of running wheels 32c are fixedly attached by eccentric screws 33c to the four lower end corners of first transfer means 31c. In particular, a high coercive magnetic member 35c such as an permanent magnet is detachably bonded to the lower side of first transfer means 31c for magnetically attracting between transfer means 31c and runway 21c while anti-slip member 38 of a disk shape made of a silicon gel or the like is detachably mounted on bottom 28 at the upper recess of transfer means 31c. First transfer means 31c and cover 39c are threaded to each other by the action of thread mechanisms 391 and 392 respectively.

When cover 39c is disposed above anti-slip member 38 as a part of support member 4c, it provides a dust-proof function and acts as a restricting means (stopper) for restricting pivotable range of joint member 5c. Preferably, cover 39c is covered at its inner side with an elastic material such as urethane resin or a gel material for attenuating the sound of collision between cover 39c and joint member 5c. Anti-slip member 38 supports from below directly curved-surface 51 of joint member 5c formed with a part of a sphere so that joint member 5c can be rotated pivotably. Bottom 28 of transfer means 31a, anti-slip member 38, and joint member 5c constitute pivotal mechanism 5c. It is found through a series of experiments that the disk size of anti-slip member 38 is preferable when its radius is substantially less or equal to ½ the horizontal radius of curved-surface 51.

The magnetic attraction force of transfer means 31c over runway 21c or base member 2c may be controlled by changing the surface area of magnetic member 35c or the diameter or the fixing location of wheels 32c to adjust the distance between magnetic member 35c and runway 21c or varying the magnetic permeability of magnetic material of runway 21c. Also, as eccentric screws 33c are turned to a specific degree, wheels 32c retract upward hence causing transfer means 31c to come in direct contact with runway 21c. Accordingly, eccentric screws 33c may be used as a lock means for locking the movement of transfer means 31c.

Support member 4c comprises an angular control mechanism (a combination of joint member 5c and thread mechanism 6c) and second transfer means (table) 71c. Joint member 5c and second transfer means 71c are detachably joined to each other by thread mechanism 6c for rotating movement. More specifically, joint member 5c is pivotably mounted at curved-surface 51 directly on anti-slip member 38 seated on bottom 28 at upper recess of first transfer means 31c so that support member 4c and first transfer means 31c serve as pivotal mechanism 5c. Joint member 5c has a male thread 63 provided in an upper cylindrical portion thereof. Male thread 63 is threaded into a female thread 64 provided in the inner wall of second transfer means 71c (of a hollow cylindrical shape), hence forming thread mechanism 6c. Thread mechanism 6c acts as a rotary mechanism operable between joint member 5c and second transfer means 71c or cradle member 8c and simultaneously as a height control mechanism for adjusting the height of surface 83.

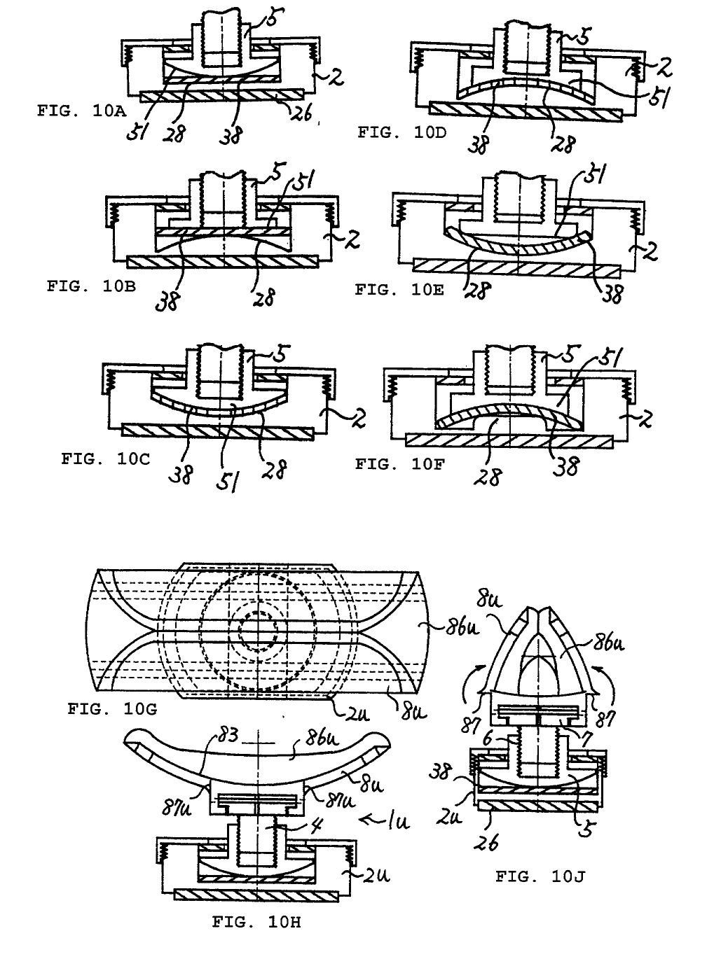

The combination between bottom 28 of transfer means 31c and curved-surface 51 may be selected from a set of six combinations shown in FIGS. 10A to 10F.

Second transfer means 71c which is an inverted form of first transfer means 31c is joined to the upper end of thread mechanism 6c by tightening members 62 (which may be formed integral with transfer means 71c) and acts as transfer table for cradle member 8c. Four transfer wheels 72c are fixedly attached to four corners of transfer means 71c by tightening members 73c such as eccentric screws. Transfer means (table) 71c has a recess provided in the upper side thereof for accommodating a high coercive magnetic material (a permanent magnet) 75c. Thread mechanism 6c joined to second transfer means 71c has a projection 65 provided on the lowermost end thereof while joint member 5c has a recess 52 provided therein corresponding to thread mechanism 6c. When projection 65 is fitted into recess 52, the height of cradle member 8c can be controlled to as a lower level as possible.

The cradle member 8c has a recess 82 of a C-shape in cross-section provided in the lower side thereof for engagement with the table and wheels 72c of second transfer means 71c. This allows cradle member 8c to slide substantially in a fore and aft direction. Also, a shallow recess is provided at recess 82 in the lower side of cradle member 8c for accommodating second runway 81c which is made of an iron material and joined to cradle member 8c by tightening member 84 inserted from surface 83 side for traveling along and on transfer means 71c. As shown in FIG. 7C, eccentric bolts 73c are adjustably provided in recess 82 for preventing the leftward and rightward dislocation of cradle member 8c when running on transfer means 71c.

Alternatively, the dislocation of cradle member 8c when running on transfer means 71c may be prevented by the effect of guiding slots provided in both outer sides of runway 81c for guiding wheels 72c or of a step between runway 81c and recess 82. Runway (carriage) 81c and second transfer means 71c thus constitute linear transfer mechanism 7c (which may be of a portal-type or a monorail-type, the latter having no projections and permitting the upper space to be saved for any other application). Magnetic attraction force of transfer means 71c over runway 81c can be controlled by varying the surface area of magnetic material 75c, changing the diameter or the fixing-location of wheels 72c, or adjusting the distance between runway 81c and magnetic material 75c.

Runway 81c accommodated in recess 82 is secured to the lower side of cradle member 8c by tightening members 84 inserted from surface 83 side. When tightening members 84 are extended into recess 82, they can act as restricting means for second transfer means 71c. Also, lock pins may be provided for insertion into a row of lock holes 88 provided at equal intervals in cradle member 8c along runway 81c. As the lock pins extend, they lock up the sliding movement of cradle member 8c. Moreover, eccentric screws 73c for tightening wheels 72c may be used as locking mechanisms. When eccentric screws 73c are turned to a specific angle, they drives wheels 72c downwardly until wheels 72c come in direct contact with runway 81c. Above described lock mechanisms may be replaced by a braking mechanism. The magnetic material of runways 21c and 81c may be selected from normal steel sheet, magnetic steel strip, electrical steel such as silicon steel, permalloy, and ferrite. High coercive magnetic members 35c and 75c may be selected from alnico magnet, ferrite magnet, and rare-earth permanent magnet such as samarium-cobalt magnet or neodymium magnet.

Transfer mechanisms 3c and 7c of a roller-type allow their corresponding transfer means 31c and 71c to travel with running wheels 32c and 72c on runways 21c and 81c respectively to transfer cradle member 8c while transfer means 31c, 71c and runways 21c, 81c are being held at their relative positions by the weight of the forearm of a user and the magnetic attraction of magnetic members 35c and 75c respectively. Transfer means 3c and 7c may be replaced with any other like means such as a slide-rail type mechanism or a non-contact type mechanism (air slider, linear motor).

In armrest 1c having cradle means 9c driven by a pair of linear transfer mechanisms 3c and 7c arranged slidable in two different directions, the forearm of a user mounted on cradle member 8c can smoothly be moved in all, leftward, rightward, forward, and backward, directions by the action of transfer means 31c and 71c with running wheels 32c and 72c while being supported from below by cradle means 9c. Also, as cradle means 9c and transfer means 31c are joined to base member 2c by the gravity of the forearm and magnetic attraction force between magnet 35c and runway 21c, cradle means 9c can easily be detached from platform 22c when simply lifted up by a force slightly greater than the magnetic attraction. Furthermore, as base member 2c is installed by detachable member 26 on surface 110 of a desk, it can be detached from the surface when softly pulled up.

The action of pivotal mechanism 5c is the same as pivotal mechanism 5a as shown in FIGS. 9A-9B and FIGS. 1B-lC.

Armrest apparatus 1c can be provided in the form of a kit. The kit hence comprises base member 2c arranged detachable directly to the surface of a desk, transfer means 31c mounted horizontally on base member 2c for traveling on wheels 32c along first runway 21c, joint member 5c pivotably mounted at one end on the interior of first transfer means 31c, support member 4c including rotatable thread mechanism 6c and transfer means 71c, cradle member 8c having second transfer mechanism 7c and runway 81c driven over transfer means 71c, anti-slip member 38 provided between support member 4c and transfer means 31c, and detachable member 26 for bonding to the bottom of detachable base member 2c, which all are packed in an appropriate package. Base member 2c in the kit can be separated into platform 22c and runway 21c. The support member 4c can be separated into first transfer means 31c, joint member 5c, and second transfer means 71c.

The procedure of assembling the components in the kit is as follows, picking out platform 22c from the kit, bonding detachable member 26 to the bottom of platform 22c, installing platform 22c on the surface of a desk, joining runway 21c by tightening members to platform 22c, mounting transfer means 31c on runway 21c, further mounting anti-slip member 38 on bottom 28 at the upper recess of transfer means 31c, mounting joint member 5c on anti-slip member 38, threading first transfer means 31c and cover 39c to each other, threading joint member 5c and second transfer means 71c to each other, and fitting cradle member 8c onto transfer means 71c on support member 4c. As a result, the assembly of armrest 1c is completed.

The combination between pivotably curved-surface 51 of joint member 5 and bottom-surface 28 at upper recess of platform 22/31 will now be explained, referring to FIG. 10. Shown in FIG. 10A is a combination between a convex curved-surface 51 of joint member 5 in cradle means 9 and a flat-plane 28 of platform 22 in base member 2. Shown in FIG. 10B is a combination between a flat-plane 51 of support member 4 and a convex curved-surface 28 of base member 2. Shown in FIG. 10C is a combination between a convex curved-surface 51 of joint member 5 and a concave curved-surface 28 of base member 2. Shown in FIG. 10D is a combination between a concave curved-surface 51 of joint member 5 and a convex curved-surface 28 of base member 2. Shown in FIG. 1OE is a combination between a flat-plane 51 of support member 4 and a concave curved-surface 28 of base member 2. Shown in FIG. 10F is a combination between a concave curved-surface 51 of joint member 5 and a flat-plane 28 of base member 2.

The above six different modes of the combination can be used with equal success. The shape of curved-surface 51 shown in FIG. 10 is predetermined according to application, and it determines the pivotal motion of joint mechanism 5a. Thus, the forearm supported by cradle means 9a can be controlled according to the shape of curved-surface 51. The relation between the shape of curved-surface 51 and pivot motion of pivotal mechanism 5a is explained more detail as follows. Six different modes of the surface-combination permit from one to three degrees of freedom (DOF) in pivot rotation.

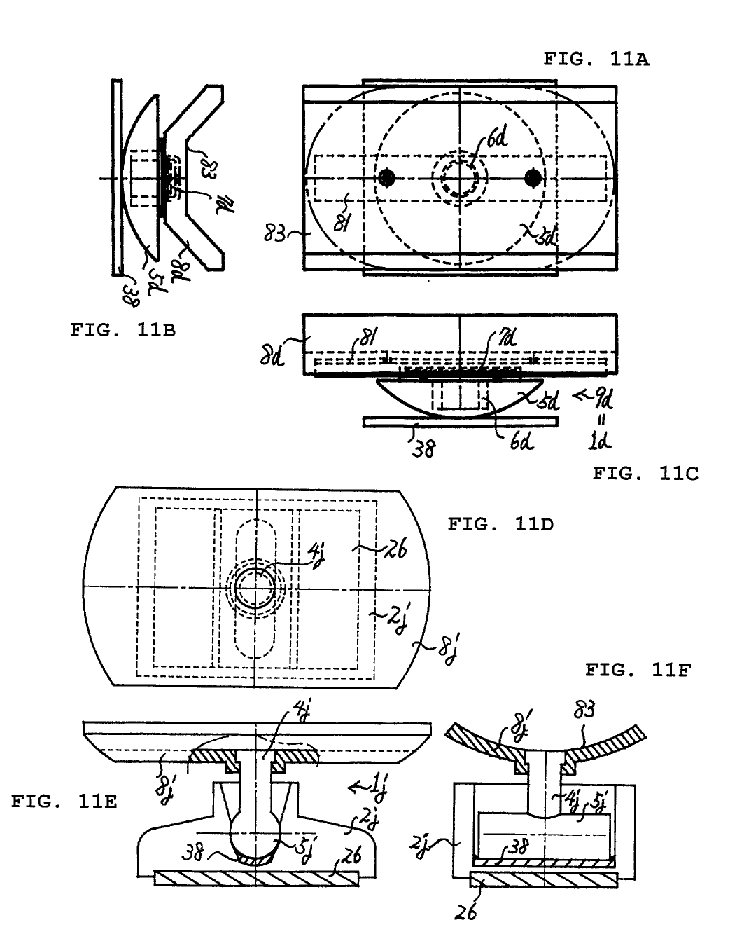

First, the combination between joint member 5 and base member 2 for pivot motion in one DOF may be implemented using a cylindrical curved-surface. FIGS. 11D to 11F related to FIG. 2 illustrate an armrest apparatus 1j according to the present invention where cradle 8j is engaged with base member 2j, and cradle member 8j is directly attached to joint member 5j. While like components are denoted by like numerals as those of the previous embodiment, joint member 5j is pivotably fitted into a upper cylindrical-recess provided in base member 2j. As curved-surface 51 of joint member 5j is directly associated with bottom curved-surface 28 in the upper recess of base member 2j, anti-slip member 38 is interposed in the pivotal space on bottom 28. In practice, the cylindrical form is positioned so that the forearm can pivotably be rotated in the forward and backward directions or its axis is arranged horizontally so that the forearm can pivotably be rotated crosswisely. When curved-surface 51 of the cylindrical form is determined for rotation along one axis, the combination between curved-surface 51 of support member 4j and surface 28 of platform 22j can be selected from six different modes shown in FIGS. 10A to 10F.

When two DOFs are needed for pivot motion, two differently specified structures may be formed: one is a modified cylindrical form which is tapered up towards both ends, the other is a same-cylindrical form accompanied at top or inside with an extra member arranged rotatable about the second-axis joined by a thread mechanism or any appropriate means. For the pivot in two different DOF, the combination between curved-surface 51 and bottom 28 of platform 22 can be selected from six different modes shown in FIGS. 10A to 10F.

When three or more DOFs are required f or pivot motion, curved-surface 51 can preferably be implemented using a sphere, a semi-sphere, an ellipsoid of revolution, a body of revolution of two-dimensional curve, a curved body of revolution, a normal curvilinear body, a cylinder, or a solid having at least a part of their combination. It is also possible to combine a member arranged pivotable in one or two DOF with a member arranged pivotable for the rotation in the third DOF. It is preferable for forming curved-surface 51 of pivot motion to use a part of a sphere or semi-sphere in view of the ease of the fabrication, a comfortable operation, and a predictable controlling of the natural operation.

As described, the combination between curved-surface 51 and bottom 28 can be selected from six different modes shown in FIGS. 10A to 10F for pivot rotations in three DOFS. In particular, pivotal mechanism 5 having a combination of the flat surface and the convex curved-surface shown in FIGS. 10A and 10B is much simpler in the structure and may preferably be employed. Also, pivotal mechanism 5 in FIG. 10A or 10B can easily be operated over a normal range of the pivot motion and translation motion, e.g. spinning and sliding of cradle member 8 on adhesive material (silicon gel) 38, as compared with a so-called ball-socket-joint motion shown in FIGS. 10C or 10D. The arrangements of a ball-socket type pivotal mechanism shown in FIGS. 10C and 10D may be implemented by rotor and stator of an electromagnetic motor or an ultrasonic motor. The movement of pivot-motor mechanism can thus be controlled by varying the position of motor revolution or the torque of revolution.

FIG. 9E related to FIGS. 6 and 10B illustrates another armrest apparatus 1e according to the present invention where armrest 1e comprises mostly a base member 2e arranged detachable to surface 110 of a desk and cradle means 9e mounted pivotably on base member 2e. While like components are denoted by like numerals as those of the previous embodiment, base member 2e consists mainly of a support member 4e, which is a combination of a platform 22e, a rotary thread 6e, and a pivotal (joint) member 5e, having a detachable structure where pivotal member 5e is threaded into a recess provided in rotatable member 6e which is a upper portion of platform 22e of support member 4e. Cradle means 9e consists only of cradle member 8e seated on an anti-slip member 38 and an engaging means 71e with a threaded cover 72e for mounting on the curved-surface of pivotal member 5e. As the curved-surface of pivotal member 5e is directly associated with bottom flat-surface 71e in a lower recess of cradle member 8e, support member 4e is included in base member 2e in FIG. 9E. The angular control mechanism of pivot 5e and rotary thread 6e is performed with the same way as in armrest 1b, and the pivotal movement may be restricted by restricting cover 72e which is detachably threaded with engaging means 71e.

FIGS. 10G to 10J related to FIG. 2 illustrate a foldable armrest apparatus 1u according to the present invention where armrest 1u comprises mostly base member 2u arranged detachable to surface 110 of a desk and cradle means 9u mounted pivotably on base member 2u. While like components are denoted by like numerals as those of the previous embodiment, cradle means 9u consists mainly of support member 4 (which is a combination of pivotal mechanism 5, rotary thread 6, and an engaging means 7) and cradle member 8u, having a foldable structure where cradle member 8u is grooved at its lower surface into a narrow slit 87u which is a member of the foldable mechanism of cradle member 8u. FIG. 10H illustrates a normal cradle state for a mouse/keyboard user where a resilient cover sheet 86u is mounted on surface 83. FIGS. 10G and 10J illustrate a folded state of cradle 8u to be portable, where the wing members of cradle 8u are folded through slit 87u to upward.

FIGS. 11A to 11C related to FIG. 6 illustrate an armrest apparatus 1d according to the present invention which has a cradle member 8d arranged for 3-d pivot motion and joined with a slide-type transfer mechanism 7d along one direction. While the principles of the action of armrest id with the forearm mounted on cradle member 8d is identical to that of armrest 1b, the number of the major components is successfully decreased. The structure of armrest id will be described in more detail referring to FIG. 11. Armrest 1d comprises mainly base member 2d (anti-slip member 38 only) and a cradle means 9d. Cradle means 9d comprises an angular control mechanism and transfer mechanism 7d and cradle member 8d. The angular control mechanism in cradle means 9d consists mainly of pivotal mechanism 5d and rotary mechanism 6d. Base member 2d arranged detachable on surface 110 of a table incorporates anti-slip member 38 which also acts as detachable member 26 while platform 22 is not provided. The angular control mechanism including pivotal mechanism 5d and rotary mechanism 6d is mounted on anti-slip member 38.

A female thread is provided in the inner wall at a recess of joint member 5d for engagement with a male thread joined by welding to the lower side of slider (transfer table) 7d on a slide rail in transfer mechanism 7d, hence constituting rotary thread 6d for rotary movement. In addition, as transfer wheels (balls) 72d are provided for the sliding movement of a carrier (rail) 81. Cradle member 8d is secured to transfer mechanism 7d by tightening members inserted from surface 83 side. Accordingly, armrest 1d allows the forearm mounted on cradle member 8d to be arbitrarily controlled for pivotal motion by joint member 5d and rotary motion by thread 6d and translation by slider 7d.

Cradle member 8d shown in FIG. 11B may be made of three, left, right, and center bottom, wooden plates sheets (which preferably have a thickness of 5 to 25 mm and more preferably 7 to 15 mm) and provided in a kit form. This allows surface 83 to be friendly with the skin of the forearm. Also, surface 83 can easily be decorated (at its upper side and/or both sides and lower side) by carving when desired. It is a good idea that the separate wooden plates are decorated by carving, painted with lacquer or pigments, and then assembled together along their ribs and slots by adhesive to cradle member 8d of a desired design. Moreover, patterns or pictures, e.g. flowers or animals, selected by the user may be printed in advance on the three wooden plates for ease of the carving. Alternatively, with no use of rotary mechanism 6d and transfer mechanism 7d shown in FIG. 11, armrest 1d may be composed of base member 2d of anti-slip member 38, pivotal member 5d, and cradle member 8d.

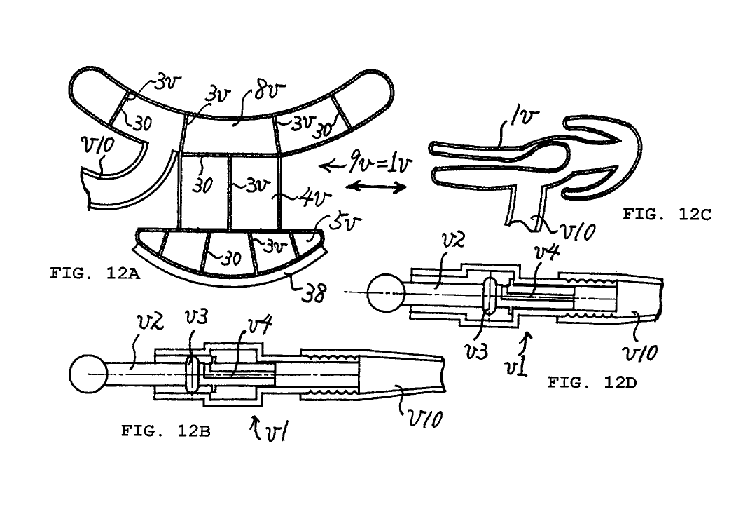

FIG. 12 related to FIGS. 6 and 11 illustrates armrest apparatus 1v made in a balloon form. Armrest 1v is basically similar in the structure to armrest 1d shown in FIG. 11B. Armrest 1v comprises a cradle means 9v only. Joint member 5v, support member 4v, and cradle member 8v are integrally formed with a balloon form into cradle means 9a from a thin, resilient material. Their chambers are separated from each other by partitions 3v. Partition 3v has a through opening 30 provided therein for passing a flow of air, water, or any other appropriate fluid. Referring to FIG. 12, a flow control means v1 having a needle member is connected at one end to a small pipe v10 below cradle member 8v. Needle member v2 having a fluid aperture opened at the distal end and a side aperture communicated by center channel is provided extending through flow control means v1. The near side of needle member v2 has an O ring v3 mounted thereon and the distal end extends into small pipe v10.

As best shown in FIG. 12D, needle member v2 is inserted into flow control means v1, allowing the fluid to be discharged out from the chambers in cradle means 9v and causing armrest 1v to stay at its contracted state (as shown in FIG. 12C) for ease of transportation. When armrest 1v is in service, needle member v2 is pushed into valve v1 (as shown in FIG. 12D) and a flow of fluid, such as compressed air, is introduced by blowing with the mouth into flow control means v1. As the chambers in cradle means 9v are filled through pipe v10 with the pressurized fluid (such as air), armrest 1v is turned to its expanded state as shown in FIG. 12A. When the pressure reaches at a desired level, needle, member v2 is drawn out from flow control means v1 (as shown in FIG. 12B) so as to hold armrest 1v at the expanded state. Then, anti-slip materials 38 and/or 26 are bonded to the lower side of joint member 5v and the installation of armrest 1v is completed. When armrest 1v is not in use, it can be exhausted and folded down to a compact size thus becoming highly portable. In FIG. 12, flow control means v1 and pipe v10 are shown as very enlarged forms to explain the structures of them very exactly.

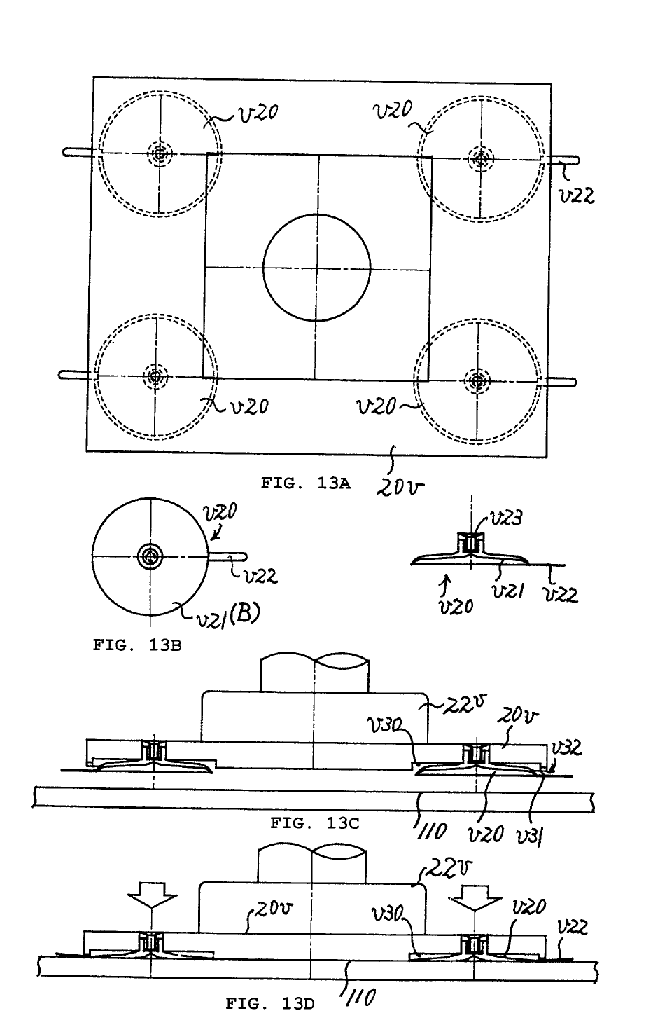

FIG. 13 related to FIG. 1B illustrates a modification where detachable member 26 is replaced by a vacuum suction type detachable member 20v. Base member 2v comprises vacuum suction bed 20v and platform 22v which are fitted with each other in this order. Vacuum suction bed 20v has a plurality of downwardly open recesses v30 (four recesses are shown in FIG. 13A) provided in the lower side thereof. Each of recesses v30 is communicated with a notch v32 having a gap v31 for passing a sheet. A vacuum suction disk v20 made of a resilient material such as plastic, urethane rubber, or gel material is fitted by adhesion, bonding, or screwing into recess v30. Vacuum suction disk v20 has a projection tab v22 provided on the upper side thereof. As projection tab v22 extends out from gap v31 and notch v32 in vacuum suction bed 20v, it can be picked up by hand. Vacuum suction bed 20v is made of an elastic material and preferably minimized in the thickness so that it can be deformed when urged from above by the cradle member not shown. As two or more of vacuum suction disks v20 are distributed at distance, platform 22v remains secured by the remaining of vacuum suction disks v20 if one of them is malfunctioned.

In action, when vacuum suction disks v20 are urged above vacuum suction bed 20v by a pressure from the cradle means not shown, they are pressed down to discharge the air from their interior, thus holding platform 22v securely on surface 110 of a desk as shown in FIG. 13D. When projection tabs v22 are pulled up by hand, they allows the air to move into the interior of vacuum suction disks v20. As all vacuum suction disks v20 are liberated, base member 2v can easily be dismounted from surface 110 of the desk.

FIG. 14 illustrates a resources-saving type desk-system sys1 where armrest 1a can be mounted and dismounted from the near side of a desk, also a display and a keyboard are mounted on each height control means 400 respectively. Desk-system sys1 is installed as follows. First a plurality of a detachable member w26 (preferably a double-sided tape having a sheet base coated at both sides with a highly adhesive material) are bonded at predetermined locations on the surface 110 of a table or desk (M1). A plurality of a retaining member w2 and/or spacer w2 (which is preferably smaller than 12 mm in the thickness, more preferably not greater than 6 mm) are mounted on each detachable member w26 (M2). A plurality of detachable member w26 (which is the same size of step M1) are bonded on the top surface of each retaining member w2 and/or spacer w2 (M3) in FIG. 14C. As shown in FIG. 14A, a thin flat-face plate w1 (which is preferably smaller than 12 mm in the thickness, more preferably not greater than 3 mm) is layered on detachable member w26 (in step M3) to be fixed to retaining members (M4).

Under a keyboard at the front side, retaining member w2 having a group of at least two recesses w3 provided in the front side thereof for accepting an upper portion w5 of a hook-like thin plate w4 is preferably interposed between flat-face plate w1 and surface 110 of a desk. Recesses w3 (which is preferably smaller than 6 mm in the thickness, more preferably not greater than 3 mm) are provided at least one or more for each retaining member w2.

The hook-like thin plate w4 (which is preferably smaller than 6 mm in the thickness, more preferably not greater than 3 mm) has a lower portion w6 (which is preferably not lower in the height of the lowest bottom face than a drawer 111 of the desk in FIGS. 14E or 14G) thereof arranged for supporting armrest 1a or 1b in FIG. 14B. While armrest 1a or 1b is installed not directly on surface 110 of the desk, it can be mounted on lower portion w6 of thin plate w4 (in FIGS. 14E or 14F) which in turn engages through upper portion w5 with recess w3 in retaining member w2 in FIGS. 14G or 14H. This eliminates the mounting and dismounting of detachable member 26 bonded to the lower side of base member 2a or 2b, thus permitting a one-touch action for installation of armrest 1a or 1b. As shown in FIG. 14G, preferably pin w8 is pushed into hole w9 for preventing thin plate w4 slipping from recess w3 when in service. This effect is also obtained by forming draft angle between upper portion w5 and recess w3, and interposing thin wedge (not shown) in it. When thin plate w4 is made of a CFRP or titanium, it can be reduced in the weight with its physical strength staying enough to stand for body weight of user. When thin plate w4 is increased in the length crosswisely of the desk but within a given range, the distance between two armrest apparatus can favorably be adjusted corresponding to the shoulder span of each user. Also, as surface 110 of the desk is free from armrest assemblies, it can be used for any other application. For example, a keyboard may be located at the front edge of thin plate w1 in FIG. 14B or 14G. When retaining member w2 for holding a side table w10 is provided (similar to retaining member w2 for holding thin plate w4) beneath thin plate w1, an extra job can be conducted on side table w10 supported by leg w11 in FIG. 14A. Accordingly, any type of computer-dedicated table will be eliminated and the given space for PC operation in an office may be used at efficiency.

A modification of the embodiment of the present invention may be provided, as shown in FIG. 14D, where a height control means 400 comprises detachable member 38a and base member 401 and moving bed 404. Base member 401 is bonded at lower side by detachable member 38a, and formed at upper side by recess 402 at least one or more. In a side face of recess 402, tooth row 403 is formed at a given pitch. While for moving bed 404, projection 405 is formed at lower side so that recess 402 can be accepted, and tooth row 408 is formed at outer side face of projection 405 according to tooth row 403. Further at projection 405, recess 406 is formed from upper side, and plunger 407 is engaged with recess 406. A height control method includes following steps, pulling out plunger 407 from recess 406 (H1), shifting the height of moving bed 404 at a desired position (H2), pushing plunger 407 into recess 406 so that tooth row 408 and 403 are engaging slidably with each other (H3), the adjusting method of means 400 is completed.

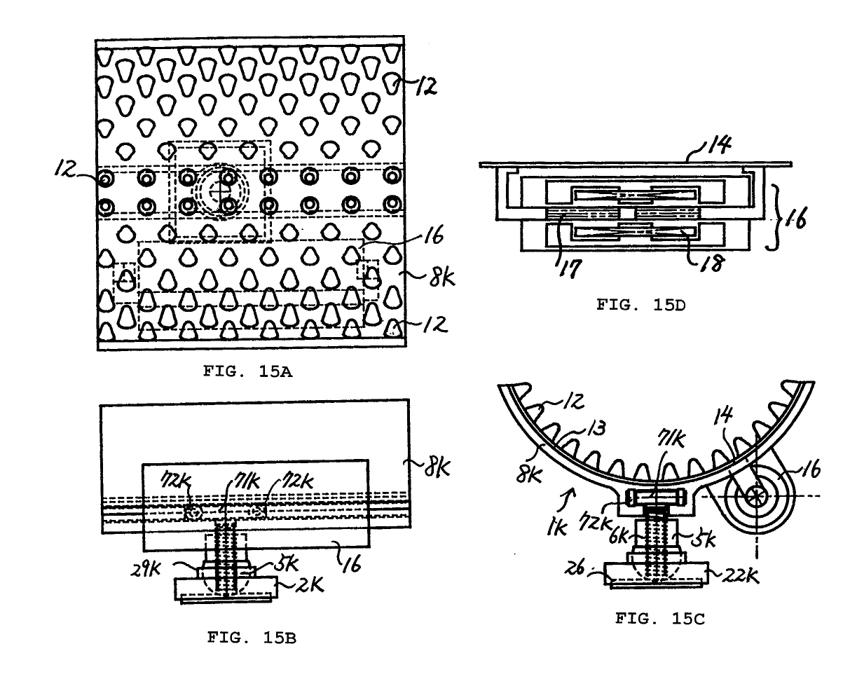

FIG. 15 illustrates an armrest apparatus 1k according to the present invention where a cradle member 8k is covered at a contact surface 83 with a mat (and/or a permeable material) on which a plurality of needle members 12 are implanted (or mounted) and an external driven rocking mechanism 16 is provided in parallel. Armrest 1k is basically similar in the structure to that shown in FIG. 2 and comprises a base member 2k, a joint member 5k, a rotary mechanism 6k, a transfer mechanism 7k, and a cradle member 8k which are joined in this order. Pivotal mechanism 5k, rotary mechanism 6k, and transfer mechanism 7k constitute a support member 4k. Support member 4k and cradle member 8k constitute a cradle means 9k.

The arrangement of armrest 1k of this embodiment will now be described in more detail referring to FIG. 15. Armrest 1k comprises mostly base member 2k and cradle means 9k. Cradle means 9k is composed of support member 4k (including pivotal mechanism 5k, rotary mechanism 6k, and transfer mechanism 7k) and cradle member 8k. Base member 2k and support member 4k are joined to each other by pivotal mechanism 5k. Also, support member 4k and cradle member 8k are joined to each other by transfer mechanism 7k. Accordingly, as the forearm of a user mounted on cradle member 8k is held in the air from below for the pivotal movement, its location and angular attitude can arbitrarily be controlled by the user in any desired motion.

The construction of base member 2k arranged detachable will be explained in more detail. Base member 2k shown in FIG. 15 comprises a platform 22k having a recess provided in the upper side thereof for pivotal mechanism 5k of a rotary-slide type and a detachable member 26 joined detachably to the lower side of platform 22k. A cover 29k having a dust-proof function and acting as a holder of joint member 5k is engaged through threading with base member 2k. In armrest 1k, joint member 5k has a relatively small radius r and supported across cover 29k in the upper recess of platform 22k. While joint member 5k acts as a rotary-slide mechanism for the pivotal movement, the thread mechanism permits platform 22k and cover 29k to be detachably joined to each other. Also, the pivotal movement of the rotary-slide mechanism can be controlled by the clamping force of thread mechanism on joint member 5k. The pivotal movement between joint member 5k and the bearing surface of platform 22k may favorably be controlled by the effect of a thread means consisting of a series of adjusting slots provided in a bearing surface at the upper recess of platform 22k.

When the bearing surface of platform 22k is made of a harder material than that of joint member 5k and has a radius slightly smaller than that of joint member 5k, the operating life of the pivotal mechanism will increase. For example, when the bearing surface is made of a hard synthetic rubber material and joint member 5k is made of a synthetic resin material, the operating life becomes longer than that with both the bearing surface and joint member 5k made of the synthetic resin material. It is also possible to have the bearing surface shaped of a convex form of a sphere and joint member 5k shaped of a concave form as shown in FIG. 10D. Alternatively, the bearing surface is made of a magnetic material such as a rare-earth magnet while joint member 5k is made of a steel ball.

Support member 4k shown in FIG. 15 includes joint member 5k, thread mechanism 6k also acting as a rotary mechanism, and a guide table 71k. Support member 4k is detachably joined to cradle member 8k by transfer mechanism 7k. More particularly, joint member 5k of support member 4k is pressed at curved-surface 51 into the upper recess of platform 22k. As support member 4k and base member 2k are joined by pivotal mechanism 5k, joint member 5k has a cylindrical recess provided in the upper side thereof. A female thread is provided at the cylindrical recess in joint member 5k for thread engagement with a male recess provided in the lower end of guide table 71k, thus constituting thread mechanism 6k. Thread mechanism 6k serves as a rotary mechanism for turning joint member 5k relative to cradle member 8k and a height control mechanism for adjusting the height of surface 83 of cradle member 8k.

Support member 4k and cradle member 8k of this embodiment are similar to support member 4b and cradle member 8b shown in FIG. 6. Surface 83 of cradle means 8k is arranged of an arch shape in the cross-section for giving a level of stability when supporting the forearm of a user. Also, as shown in FIG. 15A, surface 83 is covered with a mat (of a permeable material such as sponge or porous material, a synthetic rubber material such as urethane, artificial leather, natural fabric, porous metal, or a combination thereof) which is bonded by a detachable member 13 and on which a group and/or rows of needle-like members 12 are implanted. This allows the forearm mounted on surface 83 to be favorably massaged under its weight. Surface 83 of cradle member 8k may be covered with a stretchable supporter, fabric, or arm band which are bonded by a detachable member as not shown for identification of armrest 1k without being lost. This effect may be implemented by a magic tape bonded on surface 83. Moreover, it is desirable to construct surface 83 and/or armrest 1k with anti-bacterial, deodorant materials.

When surface 83 of cradle member 8k is made of a flexible or elastic material, it can more or less absorb any unwanted force exerted from the forearm of a user. Also, needle-like member 12 on the mat may preferably be made of a flexible or elastic material for safety. Surface 83, cradle member 8k, support member 4k, and/or base member 2k may be accompanied (or provided) in armrest 1k with permanent magnets for promotion of blood flows, a heating means such as a heater or a far-infrared ray emitter for speeding the blood flows, biological sensors such as a pulse meter, a thermometer, and a blood pressure meter for checking the conditions of the user, and a radio ID tag for radio transmission of the sensor data and identification of the user/safety, or a combination thereof.

As shown in FIGS. 15C and 15D, externally driven rocking mechanism 16, such as an eccentric motor or a rocking solenoid, which comprises a magnet 17 and a coil 18 supplied with e.g. an AC current) is embedded or mounted to the lower side of cradle member 8k or the interior of support member 4k. Upon receiving a switching current from a power supply such as a battery, externally driven rocking mechanism 16 performs a massaging action for the forearm mounted on cradle member 8k. This action is particularly effective when the operation of the hand is continuously conducted for a long period of time. Rocking mechanism 16 may be implemented by a motor driven mechanism having an eccentric load embedded or mounted on a normal motor shaft or an ultrasonic vibrator mechanism. The motor employed may be driven by AC or DC current. The DC motor may be selected from normal brush motors and permanent magnetic type brush-less motors. Rocking mechanism 16 may be fed with driving energy from base member 2k over a wireless electromagnetic induction or photoelectric system. Also, an ultrasonic vibrator mechanism using an ultrasonic motor may be used with equal success. When cradle member 8k has the ultrasonic vibrator mechanism embedded or mounted to the lower side thereof, their combination can be a single, compact rocking or vibrating system.

It is also possible to have coils embedded in base member 2k or support member 4k for feeding rocking mechanism 16 or the power supply with driving energy over a wireless electromagnetic inducting means. Alternatively, the wireless transmission of driving energy may be replaced by a pair of a light emitting device and a photoelectric device. More simply, externally driven rocking mechanism 16 may be energized from a power line. For readily discharging the static electricity developed on the user, base member 2k, support member 4k, and/or cradle member 8k may be constructed by or assorted with an electrically conductive material such as CFRP. It is also a good idea for improving the safety and sanitary that armrest 1k is subjected to anti-bacterial or deodorant treatment.

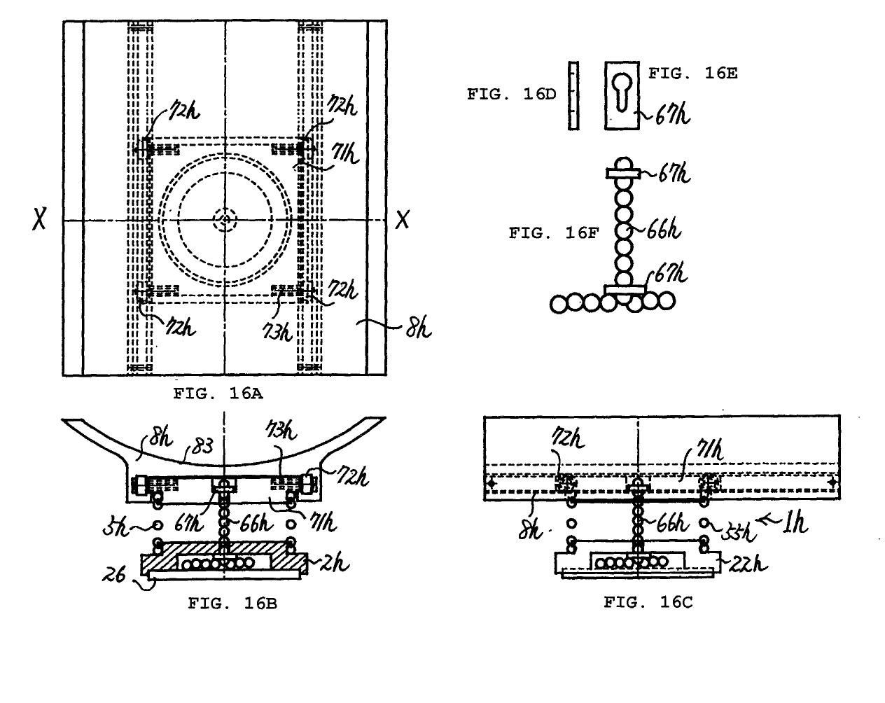

The pivotal mechanism in each armrest of the present invention is most preferable but not limited to the system shown in FIGS. 2 and 6. A similar or like arrangement of pivotal mechanism may equally be employed. FIG. 16 illustrates an armrest apparatus 1h according to the present invention where a cradle means 9h includes a slidable (transfer) mechanism 7h arranged for rocking movements in all, upward, downward, leftward, and rightward, directions and linear movement along one direction. While like components are denoted by like numerals as those explained previously, pivotal mechanism 5b in armrest 1b shown in FIG. 6 is replaced by a rocking mechanism 5h mounted on a base member 2h. This allows armrest 1h to be controlled for the rocking movements and the sliding movement. While cradle means 9h is joined with base member 2h, it is composed of rocking mechanism 5h, transfer mechanism 7h, and cradle member 8h. An angular control mechanism of cradle member 8h is formed by only rocking mechanism 5h, which comprises an elastic materials, such as a coil spring, and enables elastic-rotary motion about yaw-axis and pitch-axis, but this rotary motion is not clearly controlled by user compared with pivotal mechanism, and accompanied with irregular locational displacements.

Support member 4h mainly comprises elastic member 5h, joined at one end to a platform 22h for supporting cradle member 8h for rocking movements while a detachable member 26 of preferably an adhesive material is bonded to the lower side of platform 22h for detachable installation on the surface of a desk. Also, a height control chain 66h for adjusting the height of cradle member 8h is accommodated at one end in a recess provided in the upper side of platform 22h (between platform 22h and cradle member 8h as shown). More specifically, chain 66h is joined at both ends with limiting strips 67h, which each has such a through opening as shown in FIGS. 16D and 16E, so as to extend between the recess of platform 22h and a guide table 71h of cradle member 8h as shown in FIGS. 16B and 16F for adjusting the height of cradle member 8h.

The other end of elastic member 5h is joined to guide table 71b beneath cradle member 8h. Guide table 71h and transfer wheels 72h (rotatably mounted to guide table 71h) are accepted in a recess 82 of a C shape in the cross-section provided in the lower side of cradle member 8h, thus constituting linear transfer mechanism 7h for allowing cradle member 8h to travel substantially in a fore and aft directions.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. An armrest apparatus comprising:
a base member detachably mounted on the surface of a table or desk;
a cradle means supporting an elbow-side portion of a forearm from the wrist; and
said base member and said cradle means further including
a pivotal mechanism formed by directly connecting to each other; and
said pivotal mechanism including a pivotably curved-surface of a predetermined shape, wherein while said forearm is supported by said cradle means, the location and the attitude of said forearm can be controlled in any desired movement by said pivotal mechanism.

2. The apparatus claimed in claim 1, wherein
said base member and said cradle means further including an anti-slip member interposed between said base member and said cradle means.

3. An armrest apparatus comprising:
a base member detachably mounted on the surface of a table or desk;
a cradle means supporting an elbow-side portion of a forearm from the wrist; and
said base member and said cradle means further including
a pivotal mechanism formed by directly mounting said cradle means on said base member;
an anti-slip member interposed between said base member and said cradle means; and
said pivotal mechanism including a pivotably curved-surface of a predetermined shape, wherein while said forearm is supported by said cradle means, the location and the attitude of said forearm can be controlled in any desired movement by said pivotal mechanism.

4. The apparatus claimed in claim 2, wherein said anti-slip member includes adhesive materials, plastics, synthetic resins, resilient materials, rubber adhesive materials containing natural or synthetic rubber, acrylic adhesive materials made by copolymerization of acrylic acid ester and functional monomer, polyether/polyurethane adhesive materials, natural resins such as birdlime, and gel materials such as silicon gel or porous silicon gel, or a combination thereof.

5. The apparatus claimed in claim 2, wherein said pivotably curved-surface includes a sphere, a semi-sphere, an ellipsoid of revolution, a body of revolution of two-dimensional curve, a curved body of revolution, a normal curvilinear body, a cylinder, or a solid having at least a part of their combination.

6. The apparatus claimed in claim 2, wherein said pivotably curved-surface of a predetermined shape is comprising: at least a combination between a convex curved-surface in said cradle means and a flat-plane in said base member;
a combination between a flat-plane in said cradle means and a convex curved-surface in said base member;
a combination between a convex curved-surface in said cradle means and a concave curved-surface in said base member;
a combination between a concave curved-surface in said cradle means and a convex curved-surface in said base member;
a combination between a flat-plane in said cradle means and a concave curved-surface in said base member;
a combination between a concave curved-surface in said cradle means and a flat-plane in said base member.

7. The apparatus claimed in claim 2, further comprising a height control means of said cradle means.

8. The apparatus claimed in claim 2, further comprising the restricting means for restricting the pivotable range of said cradle means.

9. The apparatus claimed in claim 2, wherein a driving force for the pivotal movements between said cradle means and said base member is adjustable.

10. The apparatus claimed in claim 2, wherein a detachable member is attached to the bottom of said base member.

11. The apparatus claimed in claim 10, wherein said detachable member includes urethane rubber material, a vacuum suction member, a magnetic material, adhesive materials, plastics, synthetic resins, resilient materials, rubber adhesive materials containing natural or synthetic rubber, acrylic adhesive materials made by copolymerization of acrylic acid ester and functional monomer, polyether/polyurethane adhesive materials, natural resins such as birdlime, and gel materials such as silicon gel or porous silicon gel, or a combination thereof.

12. The apparatus claimed in claim 2, wherein said base member comprises a platform, a cover, and a detachable member.

13. The apparatus claimed in claim 12, wherein said cover comprises a restricting means for restricting the pivotable range of said cradle means.

14. The apparatus claimed in claim 12, wherein an anti-slip material, an annular elastic material, a gel material, or a combination of them are interposed between said cover and said cradle means.

15. The apparatus claimed in claim 2, wherein said base member and said cradle means are detachable.

16. The apparatus claimed in claim 2, wherein said armrest is accompanied with permanent magnet, a heating means, biological sensors, a pulse meter, a thermometer, a blood pressure meter, and a radio ID tag, or a combination thereof.

17. The apparatus claimed in claim 2, wherein said armrest includes an external driven rocking mechanism.

18. The apparatus claimed in claim 2, wherein said cradle means comprises a support member and a cradle member.

19. The apparatus claimed in claim 18, wherein said support member comprises a joint member and a post member.

20. The apparatus claimed in claim 18, wherein said cradle member and said joint member are rotatably connected with each other.

21. The apparatus claimed in claim 18, wherein the length of said support member is adjustable.

22. The apparatus claimed in claim 18, wherein said cradle means comprises an engaging means which is a fore and aft adjusting means of said cradle member.

23. The apparatus claimed in claim 18, wherein said cradle means comprises a transfer mechanism which transfer said cradle member linearly.

24. The apparatus claimed in claim 18, wherein said transfer mechanism includes a lock means of said transfer mechanism.

25. The apparatus claimed in claim 18, wherein said cradle member is formed into an arch shape in cross-section and rounded at the corners of both ends.

26. The apparatus claimed in claim 18, wherein said cradle member is covered at a contact surface with a plurality of needle members, a permeable material such as sponge or porous material, a synthetic rubber material such as urethane, artificial leather, natural fabric, porous metal, or a combination thereof.

27. The apparatus claimed in claim 18, wherein said cradle member is foldable.

28. An armrest apparatus comprising:
a cradle means supporting an elbow-side portion of a forearm from the wrist;
a pivotal mechanism formed by directly mounting said cradle means on the surface of a table or desk;
an anti-slip member interposed between said cradle means and said surface of a desk; and
said pivotal mechanism including a pivotably curved-surface of a predetermined shape, wherein while said forearm is supported by said cradle means, the location and the attitude of said forearm can be controlled in any desired movement by said pivotal mechanism.

29. The apparatus claimed in claim 28, wherein said anti-slip member includes adhesive materials, plastics, synthetic resins, resilient materials, rubber adhesive materials containing natural or synthetic rubber, acrylic adhesive materials made by copolymerization of acrylic acid ester and functional monomer, polyether/polyurethane adhesive materials, natural resins such as birdlime, and gel materials such as silicon gel or porous silicon gel, or a combination thereof.

30. The apparatus claimed in claim 28, wherein said pivotably curved-surface includes a sphere, a semi-sphere, an ellipsoid of revolution, a body of revolution of two-dimensional curve, a curved body of revolution, a normal curvilinear body, a cylinder, or a solid having at least a part of their combination.

31. The apparatus claimed in claim 28, wherein said pivotably curved-surface of a predetermined shape comprises a convex curved-surface.

32. The apparatus claimed in claim 28, further comprising a height control means of said cradle means.

33. The apparatus claimed in claim 28, further comprising the restricting means for restricting the pivotable range of said cradle means.

34. The apparatus claimed in claim 28, wherein a driving force for the pivotal movements between said cradle means and said surface of the desk is adjustable.

35. The apparatus claimed in claim 33, wherein an anti-slip material, an annular elastic material, a gel material, or a combination of them are interposed between said restricting means and said cradle means.

36. The apparatus claimed in claim 28, wherein said armrest is accompanied with permanent magnet, a heating means, biological sensors, a pulse meter, a thermometer, a blood pressure meter, and a radio ID tag, or a combination thereof.

37. The apparatus claimed in claim 28, wherein said armrest includes an external driven rocking mechanism.

38. The apparatus claimed in claim 28, wherein said cradle means comprises a support member and a cradle member.

39. The apparatus claimed in claim 38, wherein said support member comprises a joint member and a post member.

40. The apparatus claimed in claim 38, wherein said cradle member and said joint member are rotatably connected with each other.

41. The apparatus claimed in claim 38, wherein the length of said support member is adjustable.

42. The apparatus claimed in claim 38, wherein said cradle means comprises an engaging means which is a fore and aft adjusting means of said cradle member.

43. The apparatus claimed in claim 38, wherein said cradle means comprises a transfer mechanism which transfer said cradle member linearly.

44. The apparatus claimed in claim 38, wherein said transfer mechanism includes a lock means of said transfer mechanism.

45. The apparatus claimed in claim 38, wherein said cradle member is formed into an arch shape in cross-section and rounded at the corners of both ends.

46. The apparatus claimed in claim 38, wherein said cradle member is covered at a contact surface with a plurality of needle members, a permeable material such as sponge or porous material, a synthetic rubber material such as urethane, artificial leather, natural fabric, porous metal, or a combination thereof.

47. The apparatus claimed in claim 38, wherein said cradle member is foldable.

48. The apparatus claimed in claim 28, wherein said cradle means are integrally formed with a balloon form.

49. A method for installing an armrest apparatus on a surface of a desk, said armrest apparatus including a base member detachably mounted on the surface of the desk and a cradle means supporting an elbow-side portion of a forearm from the wrist, the steps of the method comprising:
forming a pivotal mechanism by directly connecting said base member and said cradle means to each other; and,
mounting said base member on said surface of the desk at a desired location.

50. The method claimed in claim 49, wherein said forming step includes interposing an anti-slip member between said base member and said cradle means.

51. The method claimed in claim 50, wherein said anti-slip member includes adhesive materials, plastics, synthetic resins, resilient materials, rubber adhesive materials containing natural or synthetic rubber, acrylic adhesive materials made by copolymerization of acrylic acid ester and functional monomer, polyether/polyurethane adhesive materials, natural resins such as birdlime, and gel materials such as silicon gel or porous silicon gel, or a combination thereof.

52. The method claimed in claim 49, wherein said forming step includes interposing an anti-slip member between said base member and said cradle means.

53. The method claimed in claim 49, comprising the additional step of controlling a height of said cradle means.

54. The method claimed in claim 49, comprising the additional step of restricting the pivotable range of said cradle means.

55. The method claimed in claim 49, comprising the additional step of adjusting a driving force for the pivotal movements between said cradle means and said base member.

56. The method claimed in claim 49, comprising the additional step of attaching a detachable member to the bottom of said base member.

57. The method claimed in claim 56, wherein said detachable member includes urethane rubber material, a vacuum suction member, a magnetic material, adhesive materials, plastics, synthetic resins, resilient materials, rubber adhesive materials containing natural or synthetic rubber, acrylic adhesive materials made by copolymerization of acrylic acid ester and functional monomer, polyether/polyurethane adhesive materials, natural resins such as birdlime, and gel materials such as silicon gel or porous silicon gel, or a combination thereof.

58. The method claimed in claim 49, wherein said base member comprises a platform, a cover, and a detachable member.

59. The method claimed in claim 49, wherein said armrest is accompanied with permanent magnet, a heating means, biological sensors, a pulse meter, a thermometer, a blood pressure meter, and a radio ID tag, or a combination thereof.

60. The method claimed in claim 49, wherein said armrest includes an external driven rocking mechanism.

61. The method claimed in claim 49, wherein said cradle means comprises a support member and a cradle member.

62. The method claimed in claim 61, wherein said support member comprises a joint member and a post member.

63. The method claimed in claim 61, wherein said cradle means comprises an engaging means which is a fore and aft adjusting means of said cradle member.

64. The method claimed in claim 61, wherein said cradle means comprises a transfer mechanism which transfer said cradle member linearly.

65. The method claimed in claim 61, wherein said cradle member is covered at a contact surface with a plurality of needle members, a permeable material such as sponge or porous material, a synthetic rubber material such as urethane, artificial leather, natural fabric, porous metal, or a combination thereof.

66. The method claimed in claim 49, comprising the additional step of dismounting said armrest apparatus.

67. A method for installing an armrest apparatus on a surface of a desk, said armrest apparatus including a cradle means supporting an elbow-side portion of a forearm from the wrist and mounted directly on the surface of a desk, the steps of the method comprising:
forming a pivotal mechanism by directly connecting said cradle means and said surface of the desk to each other; and,
interposing an anti-slip member between said cradle means and said surface of the desk.

68. The method claimed in claim 67, wherein said anti-slip member includes adhesive materials, plastics, synthetic resins, resilient materials, rubber adhesive materials containing natural or synthetic rubber, acrylic adhesive materials made by copolymerization of acrylic acid ester and functional monomer, polyether/polyurethane adhesive materials, natural resins such as birdlime, and gel materials such as silicon gel or porous silicon gel, or a combination thereof.

69. The method claimed in claim 67, comprising the additional step of controlling a height of said cradle means.

70. The method claimed in claim 67, comprising the additional step of restricting the pivotable range of said cradle means.

71. The method claimed in claim 67, wherein said armrest is accompanied with permanent magnet, a heating means, biological sensors, a pulse meter, a thermometer, a blood pressure meter, and a radio ID tag, or a combination thereof.

72. The method claimed in claim 67, wherein said armrest includes an external driven rocking mechanism.

73. The method claimed in claim 67, wherein said cradle means comprises a support member and a cradle member.

74. The method claimed in claim 73, wherein said support member comprises a joint member and a post member.

75. The method claimed in claim 73, wherein said cradle means comprises an engaging means which is a fore and aft adjusting means of said cradle member.

76. The method claimed in claim 73, wherein said cradle means comprises a transfer mechanism which transfer said cradle member linearly.

77. The method claimed in claim 73, wherein said cradle member is covered at a contact surface with a plurality of needle members, a permeable material such as sponge or porous material, a synthetic rubber material such as urethane, artificial leather, natural fabric, porous metal, or a combination thereof.
